(19) United States
(12) Patent Application Publication
(10) Pub. No.: US 2006/0188855 A1
(43) Pub. Date: Aug. 24, 2006

(54) Gaming system and typing game apparatus

(75) Inventors: Kazuo Okada, Tokyo (JP); Jun Fujimoto, Tokyo (JP); Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE Corporation, Tokyo (JP)

(21) Appl. No.: 11/338,882

(22) Filed: Jan. 25, 2006

(30) Foreign Application Priority Data
Jan. 26, 2005 (JP) 2005-018568

(51) Int. Cl. G09B 13/00

(52) U.S. Cl. 434/227; 434/350

(57) ABSTRACT

To provide a typing game apparatus which can attract public interest in the typing game apparatus and which enables the display of a commercial advertisement and can thus increase spectator's willingness to buy a commercial product related to the commercial advertisement, and a gaming system using the typing game apparatus.

Song data and advertisement data are distributed to a typing game apparatus 1 from a server 80 via a game communication section 25, and are stored in a song data storage area 20a and an advertisement data storage area 20b, respectively. When no typing game is being executed, a music advertisement or a commercial advertisement in a demonstration play of the typing game is performed based on the song data or the advertisement data. On this occasion, based on LED emission pattern data and keyboard emission pattern data, which are included in the song data and the advertisement data, the emission modes of an external illumination LED 6 and a keyboard 3 are controlled to perform the effect of the music advertisement or the commercial advertisement.

### RELATED APPLICATION

This application claims the priority of Japanese Patent Application No. 2005-018568 filed on Jan. 26, 2005, which is incorporated herein by reference.

### BACKGROUND OF THE INVENTION

1. Technical Field

The present invention relates to a typing game apparatus which can attract public interest in the typing game apparatus and which enables the display of a commercial advertisement and can thus increase spectator's willingness to buy a commercial product related to the commercial advertisement, and to a gaming system using the typing game apparatus.

2. Related Art

Currently, a variety of games have been developed through an advance in electronic information technology, and are enjoyed by a large number of users irrespective of age and sex. Some games are prevalent which incorporate a commercial advertisement, expecting an advertising effect in the game with an increase in the gaming population.

For example, a gaming apparatus, which displays the corporate symbol of a gaming apparatus maker or a game program maker at the time of power activation or at the start of the execution of a game program, is common among home video gaming apparatuses and arcade video gaming apparatuses which are currently in circulation.

However, such a corporate symbol, which is displayed at the time of activation, promotes the corporate image rather than advertises their commercial product, and is not an advertisement which generates commercial profits.

Besides, when the mode is adopted in which a commercial advertisement of a product or the like is displayed at the time of the power activation of a gaming apparatus or during the execution of a game program, because this commercial advertisement is already incorporated in the system program of the gaming apparatus or the game program of its game software, it is very difficult to change this commercial advertisement to the commercial advertisement of a new product. In other words, when a gaming apparatus is installed by a user or in a shop, it follows that an old commercial advertisement is displayed thereon, which cannot encourage user's willingness to buy the new product.

On the other hand, as a gaming apparatus and a game program in which a commercial advertisement is displayed during a game, there are inventions disclosed in Japanese Unexamined Patent Publication No. 9-010440 and Japanese Unexamined Patent Publication No. 2004-215722.

For example, Japanese Unexamined Patent Publication No. 9-010440 discloses an invention configured as follows. That is, in a gaming system including a network server and a gaming apparatus connected to the server, in a game program to be executed by the gaming apparatus, image data in the server, which indicates an advertisement, is changed, thereby changing, when appropriate, an advertising image displayed as a background during a game or an advertising image displayed as part of the clothing of a character.

Besides, Japanese Unexamined Patent Publication No. 2004-215722 discloses an invention configured as follows. That is, in a massively multiplayer online role playing game system including a server and a gaming apparatus, event information or advertising information, which corresponds to user's personal information, is retrieved from the server, and the retrieved information is displayed on a screen on which a game is being executed.

However, in the gaming system disclosed in Japanese Unexamined Patent Publication No. 9-010440, the advertisement is simply displayed as part of a game screen. In general, a player, who is concentrating on the game, concentrates so much attention on the story or operation of the game that he/she pays less attention to the advertising image being displayed as part of the background or part of clothing of the character.

Accordingly, the display of the advertisement during the game in Japanese Unexamined Patent Publication No. 9-010440 lacks an effective appeal to the player.

In the massively multiplayer online role playing game system disclosed in Japanese Unexamined Patent Publication No. 2004-215722, an advertisement based on personal information is performed in the mode in which the character during the game conveys the event information and the advertising information. However, since the advertisement is performed only by representation in the game screen with an image or character, when the user is concentrating on the game, he/she feels that an advertising portion is unnecessary, and will therefore pay no attention to the advertisement, which leads to a great reduction in advertising appeal.

Japanese Unexamined Patent Publication No. 2004-215722 also discloses that sound data notifies the user of the content of the advertisement. However, in this case, the content of the advertisement intrudes as a sound into game music being played during the game, so that user's consciousness is brought back to reality, which reduces the pleasure of the game.

Here, to consider, from a user's position, the point that the advertisement is performed during the game, the “advertisement based on the user's personal information” is suddenly performed while the user is enjoying the game, so that his/her consciousness is brought back to reality, which creates the situation in which the user cannot fully enjoy the game. By reason that an advertisement has the aspect of improving the favorable public image of a commercial product and a company, an advertisement which prevents the user from enjoying the game can put the company at a disadvantage.

The invention, which has been made in view of the aforementioned problems, relates to a gaming system, and especially has as its object the provision of a gaming system which can attract public interest in a typing game apparatus and which enables the display of a commercial advertisement and can thus encourage a spectator's willingness to buy a commercial product related to the commercial advertisement, and a typing game apparatus which is used in the gaming system.

### SUMMARY OF THE INVENTION

To achieve this object, according to a first aspect of the invention, a typing game apparatus comprises: a image display capable of displaying a character string to be input and an image during a typing game; an input device for inputting the character string; a sound production section for producing a sound based on music data; an illumination section for performing a turning on and off effect; a communication section which receives effect data, which includes image data, music data, and emission control data defining the emission mode of the illumination section, from a server having a database which stores the effect data; and a CPU which displays a predetermined image on the image display, based on the effect data, when an input operation using the input device has not been performed for a predetermined time period, and which controls the emission mode of the illumination section based on the emission control data.

According to a second aspect of the invention, in a typing game apparatus according to the first aspect of the invention, the image display includes: a first display for displaying the character string; and a second display for displaying a predetermined image based on the image data, and the effect data includes: song data which includes image data, music data, emission control data, and lyrics data, and which is used in conjunction with the typing game; and advertisement data for use in a commercial advertisement, which includes image data, music data, and emission control data.

According to a third aspect of the invention, in a typing game apparatus according to the second aspect of the invention, upon reception of the advertisement data from the server through the communication section, the CPU displays an image of an advertisement on the second display based on the image data, produces a sound through the sound production section based on the music data, and controls the emission mode of the illumination section based on the emission control data.

According to a fourth aspect of the invention, in a typing game apparatus according to the second aspect of the invention, upon reception of the song data from the server through the communication section, the CPU displays an image related to the song data to be used in a typing game, based on the image data of the song data on the first display and also, displays an image of a music advertisement corresponding to the song data on the second display, produces a sound through the sound production section based on the music data of the song data, and controls the emission mode of the illumination section based on the emission control data of the song data.

According to a fifth aspect of the invention, in a typing game apparatus according to the first aspect of the invention, the input device is a keyboard having a transparent keycap and an emission section which emits light from below the keycap, wherein the keyboard also functions as part of the illumination section.

According to a sixth aspect of the invention, a gaming system comprises: a typing game apparatus according to the second to fifth aspects of the invention; and a server including a song database having the song data stored therein, an advertisement database having the advertisement data stored therein, and a transmission section which transmits both or any of the song data and the advertisement data to the typing game apparatus.

According to an aspect of the invention, when an input operation using the input device has not been performed for a predetermined time period, an effect corresponding to effect data is performed by the image display and the illumination section. Therefore, even when no typing game is being performed, it is possible to attract a spectator's interest.

Furthermore, effect data can be distributed to the typing game apparatus from the server via the communication section. Therefore, it becomes possible to perform an effect based on new effect data when appropriate, which makes it possible to always perform an effect full of freshness and thus reduce the degree of a decrease in the effect of attracting spectator's interest.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

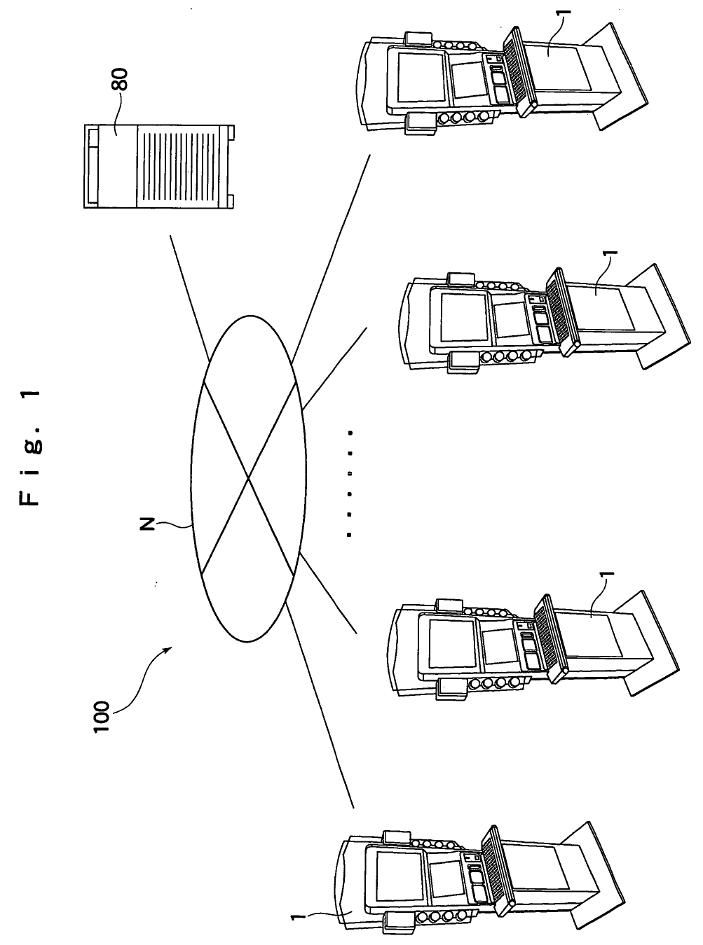

FIG. 1 is an illustration of a gaming system according to an embodiment;

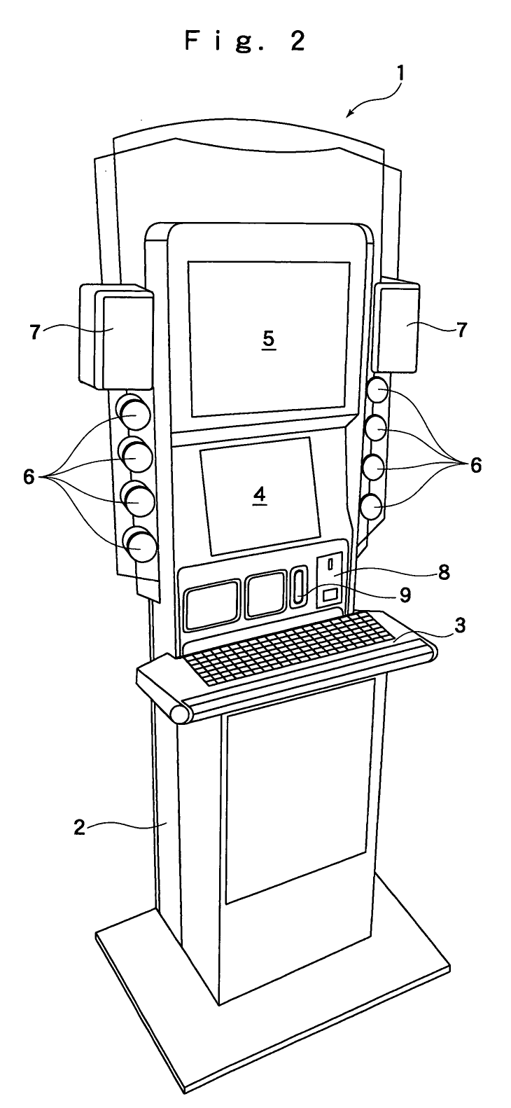

FIG. 2 is an exterior perspective view of a typing game apparatus included in the gaming system according to the embodiment;

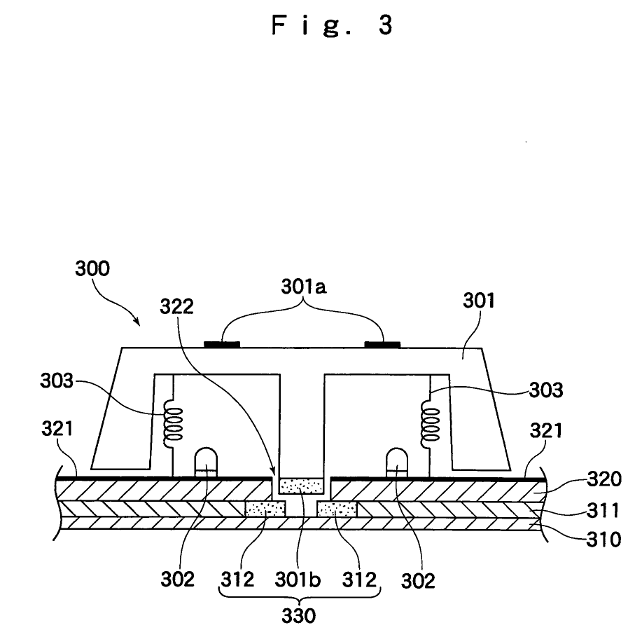

FIG. 3 is a cross-section illustration of any one of plural keys arranged on a keyboard of the typing game apparatus according to the embodiment;

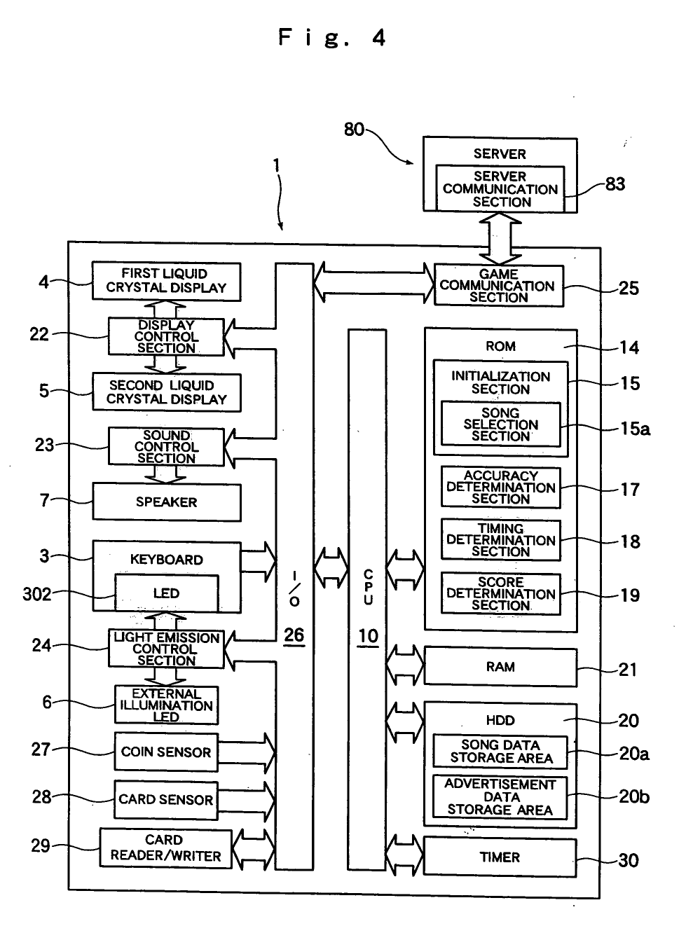

FIG. 4 is a block diagram showing the control system of the typing game apparatus according to the embodiment;

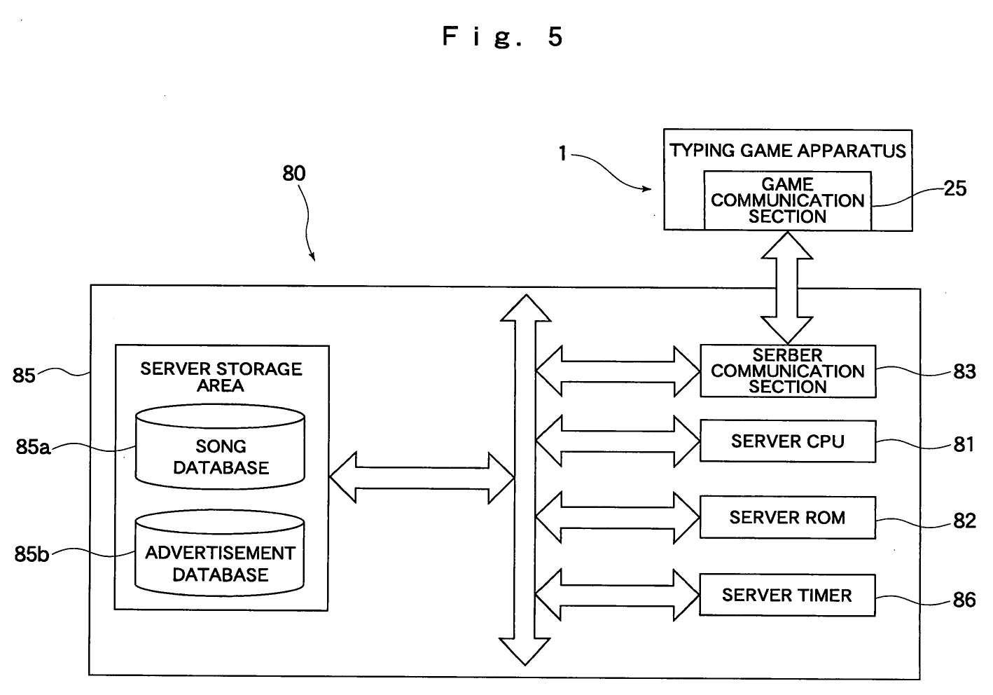

FIG. 5 is a block diagram showing the control system of a server according to the embodiment;

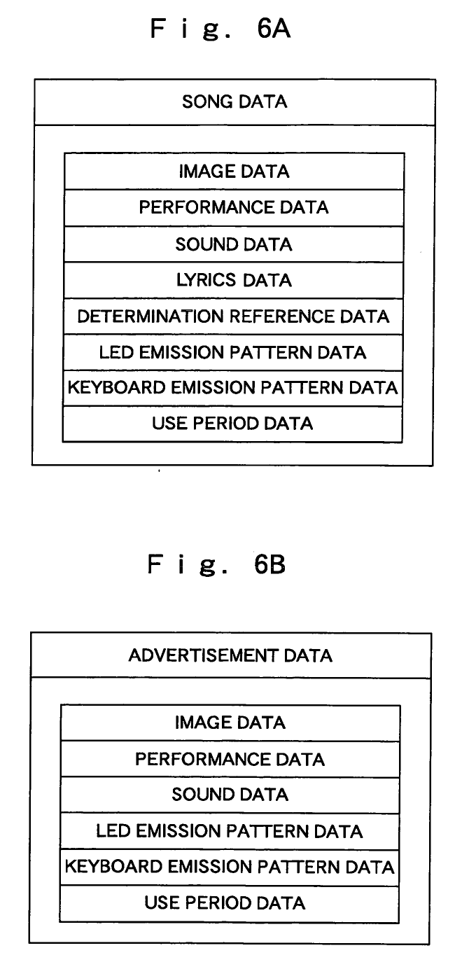

FIGS. 6A and 6B are illustrations of song data and advertisement data which are stored in the typing game apparatus and the server according to the embodiment;

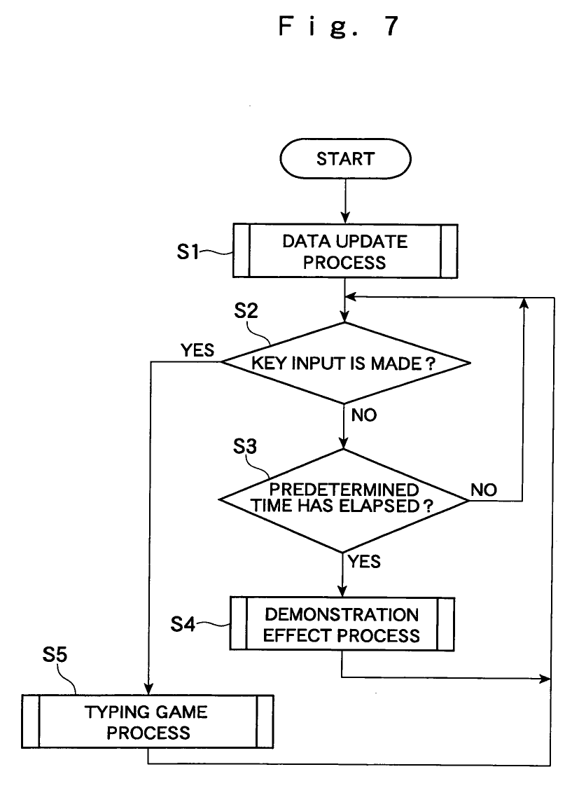

FIG. 7 is a flowchart of a main control program of the typing game apparatus according to the embodiment;

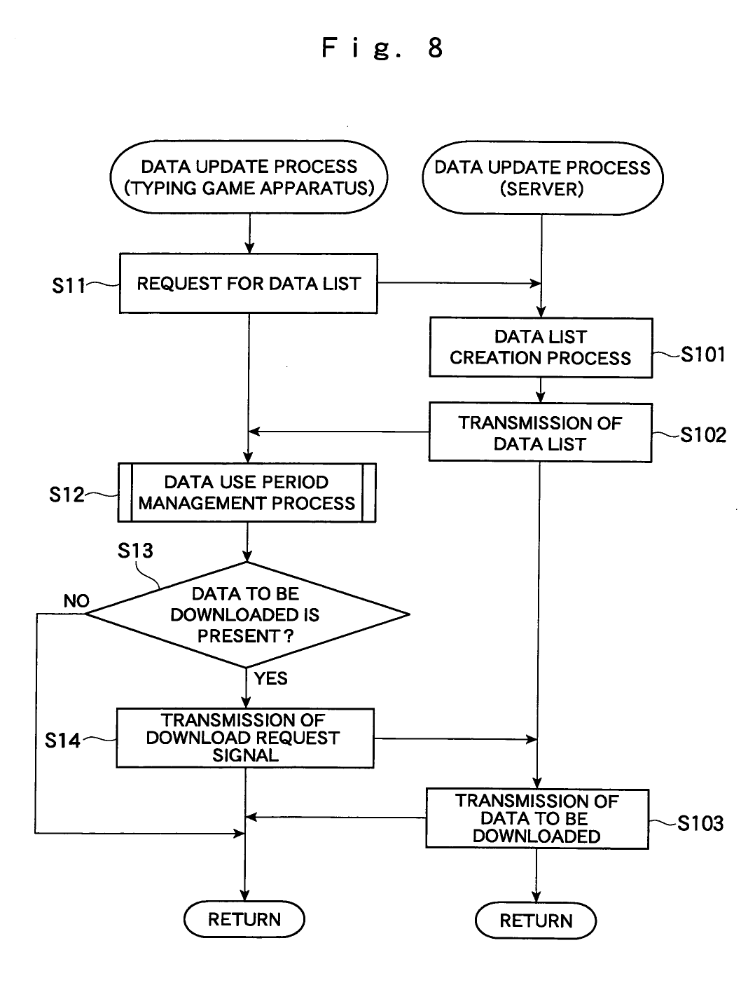

FIG. 8 is a flowchart of a data update processing program of the typing game apparatus according to the embodiment;

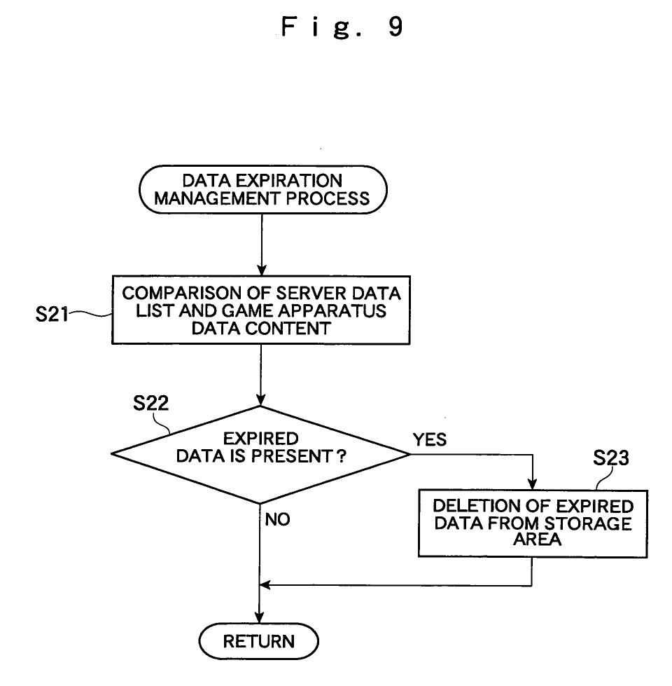

FIG. 9 is a flowchart of a data use period management processing program of the typing game apparatus according to the embodiment;

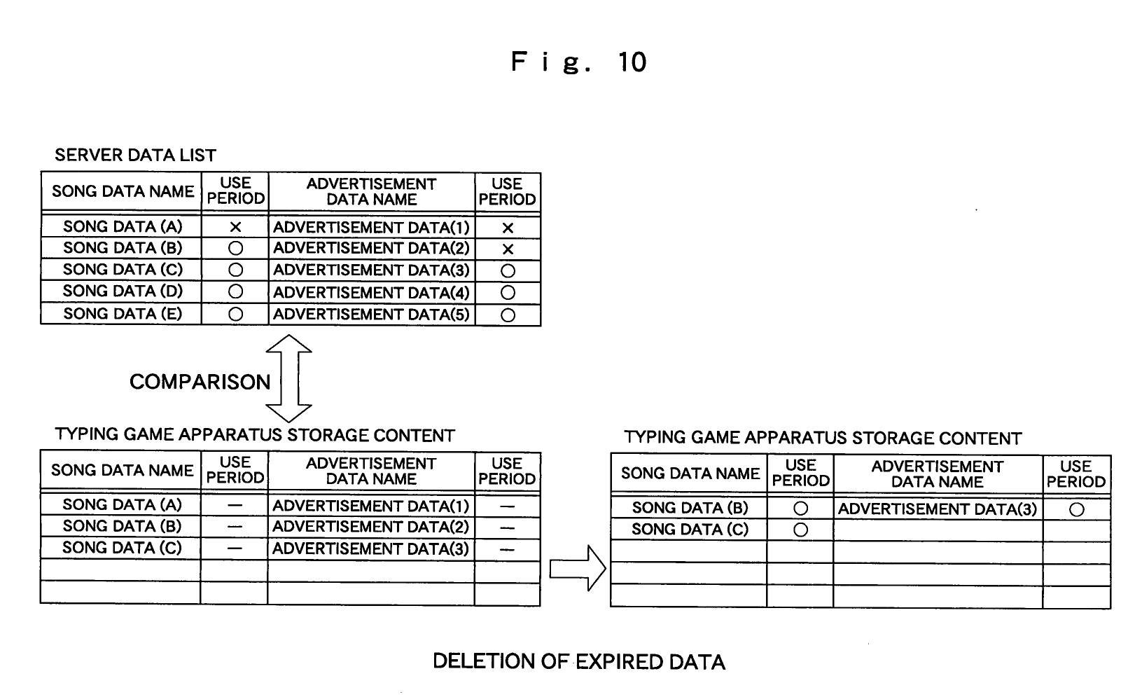

FIG. 10 is an illustration of a data use period management process which is performed on the typing game apparatus according to the embodiment;

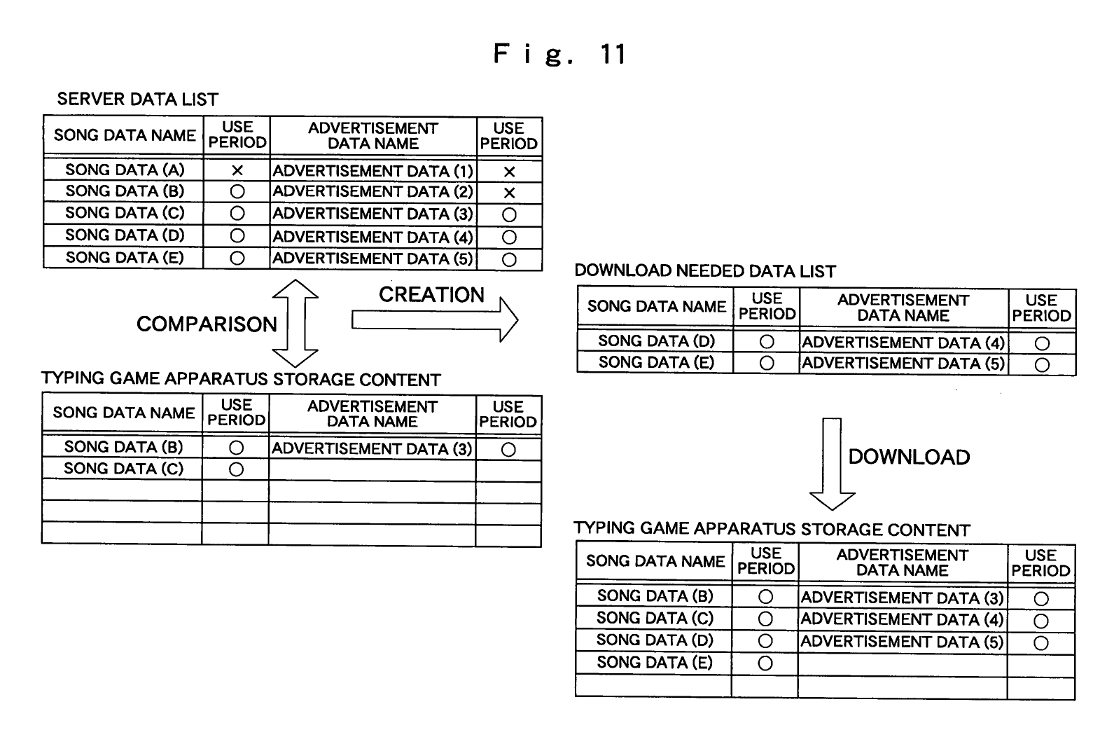

FIG. 11 is an illustration of a data update process according to the embodiment;

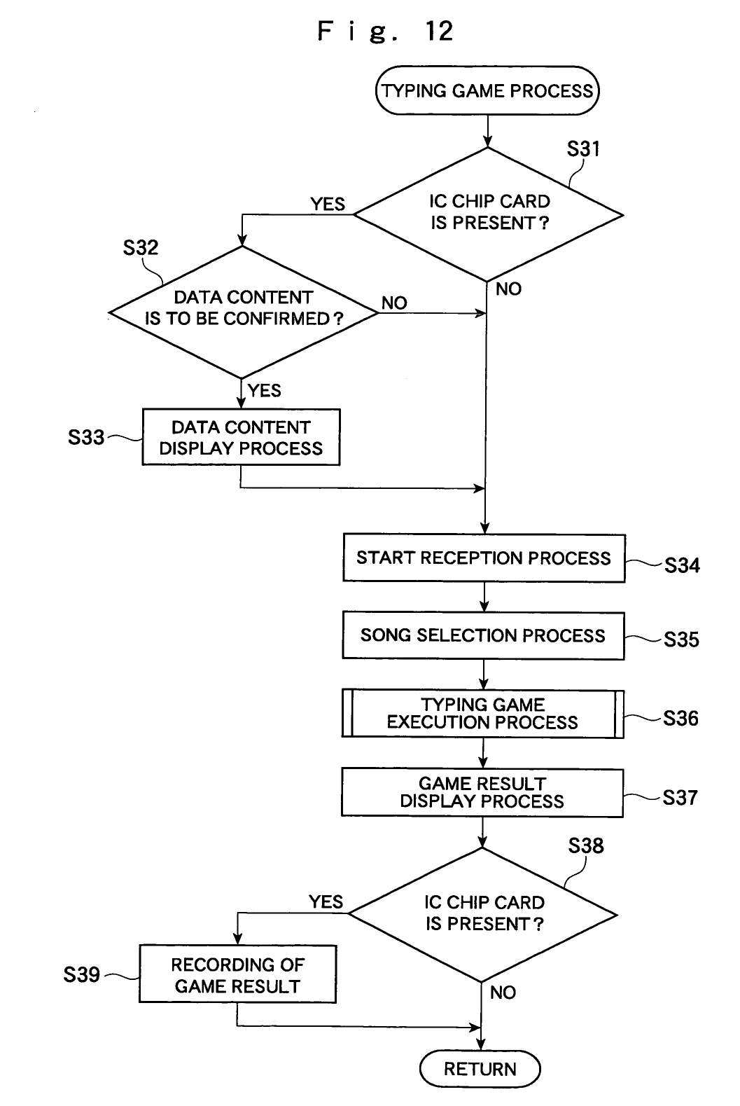

FIG. 12 is a flowchart of a typing game processing program of the typing game apparatus according to the embodiment;

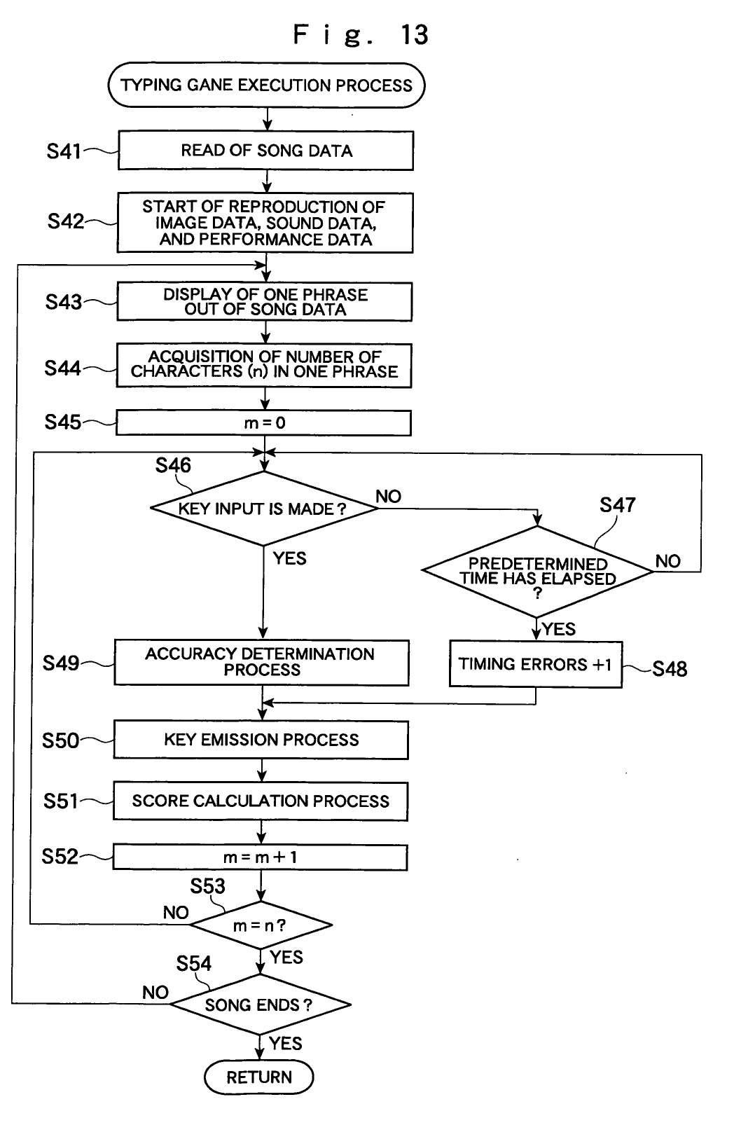

FIG. 13 is a flowchart of a typing game execution processing program of the typing game apparatus according to the embodiment;

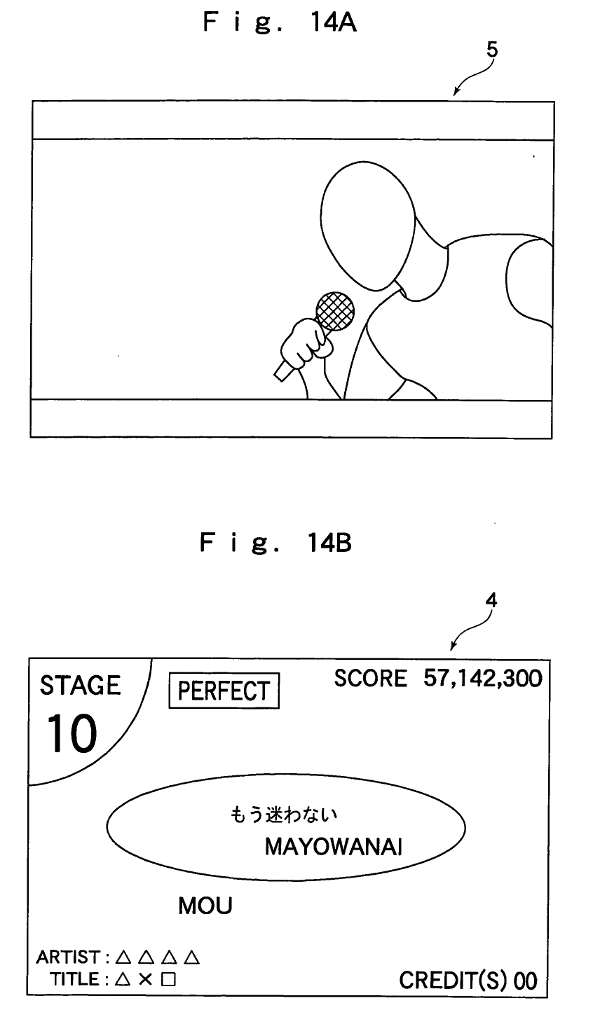

FIGS. 14A and 14B are display examples (1) of respective liquid crystal displays during the execution of a typing game according to the embodiment, wherein FIG. 14A shows a display example of a second liquid crystal display, and FIG. 14B shows a display example of a first liquid crystal display;

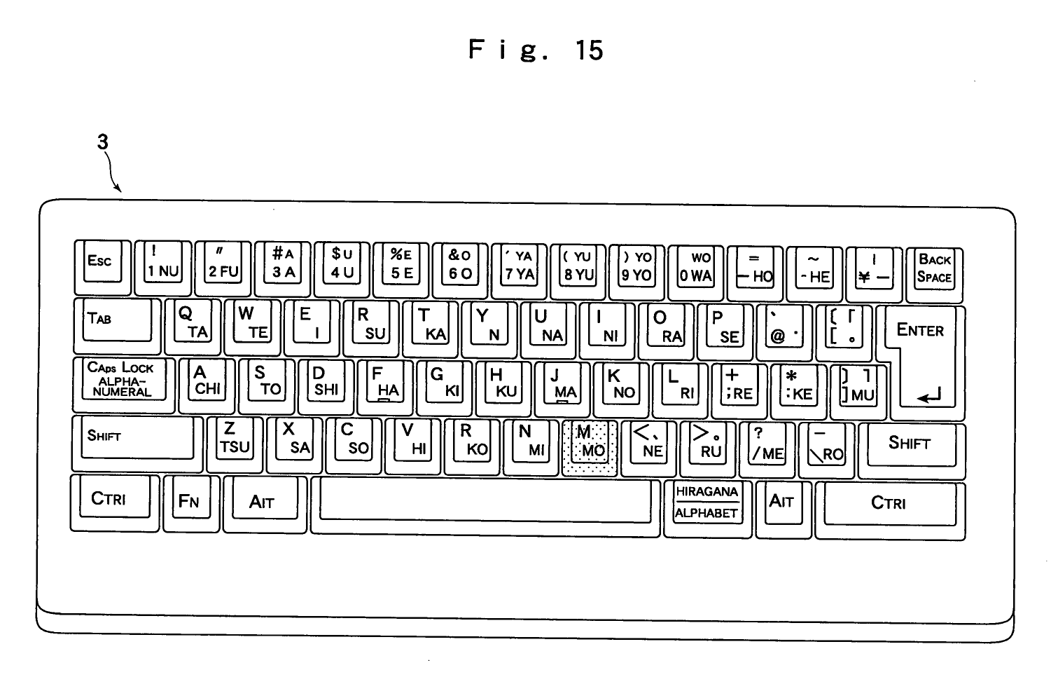

FIG. 15 is an illustration showing an emission mode example of the keyboard during the execution of the typing game according to the embodiment;

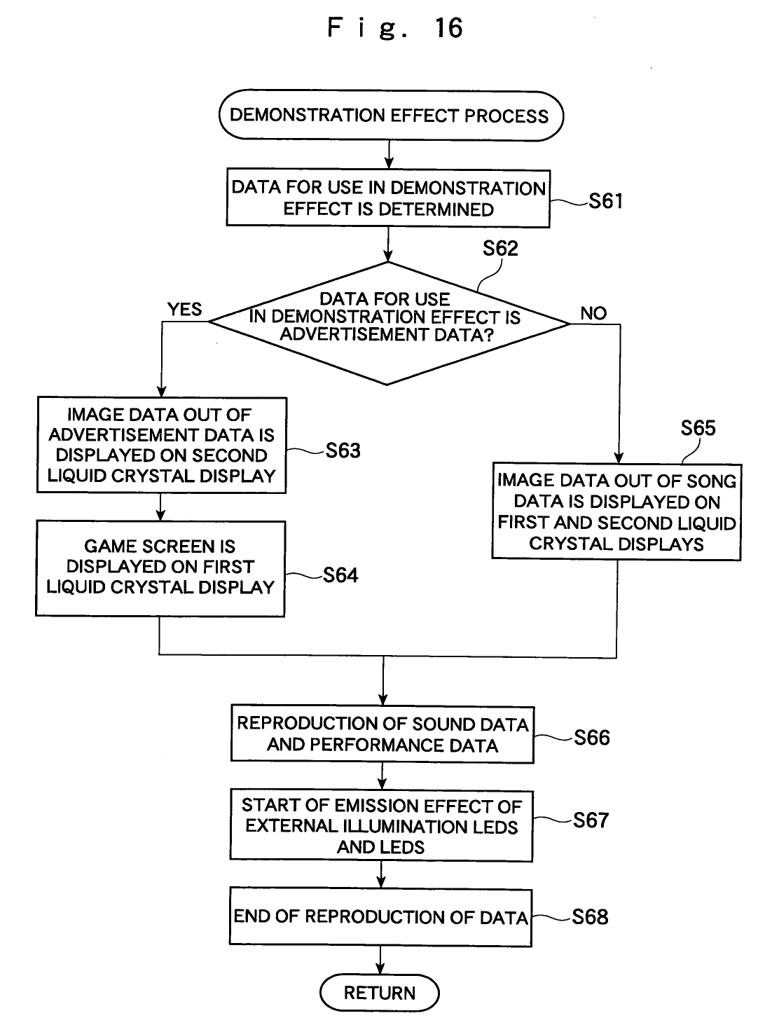

FIG. 16 is a flowchart of a demonstration effect processing program of the typing game apparatus according to the embodiment;

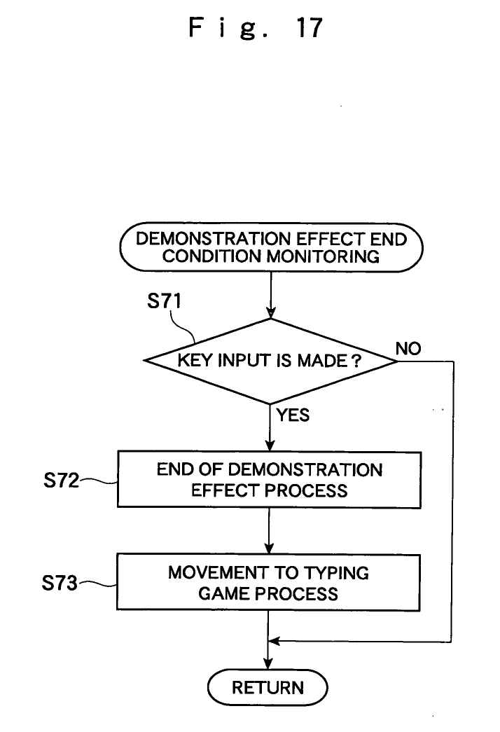

FIG. 17 is a flowchart of a demonstration effect end condition monitoring program of the typing game apparatus according to the embodiment;

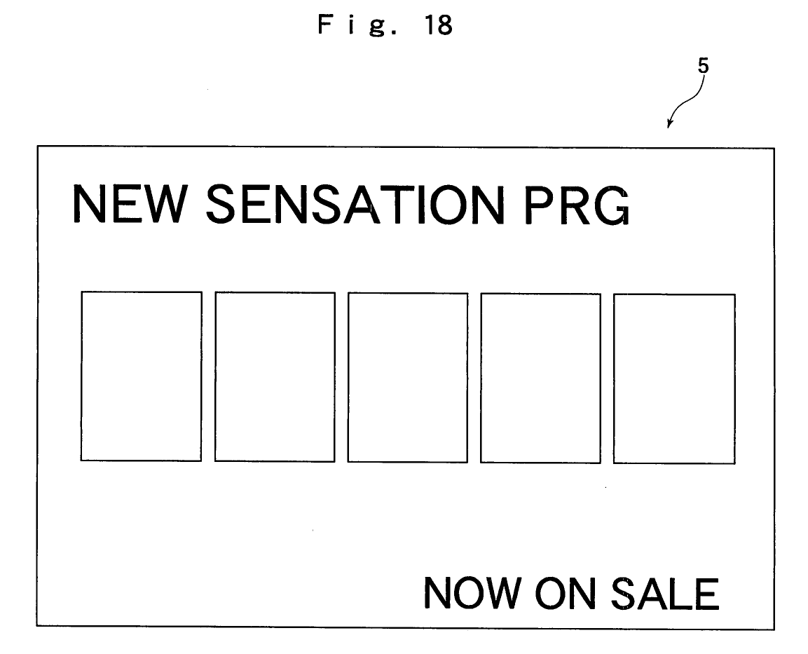

FIG. 18 is a display example (1) of the first liquid crystal display when a commercial advertisement is being performed in the typing game according to the embodiment;

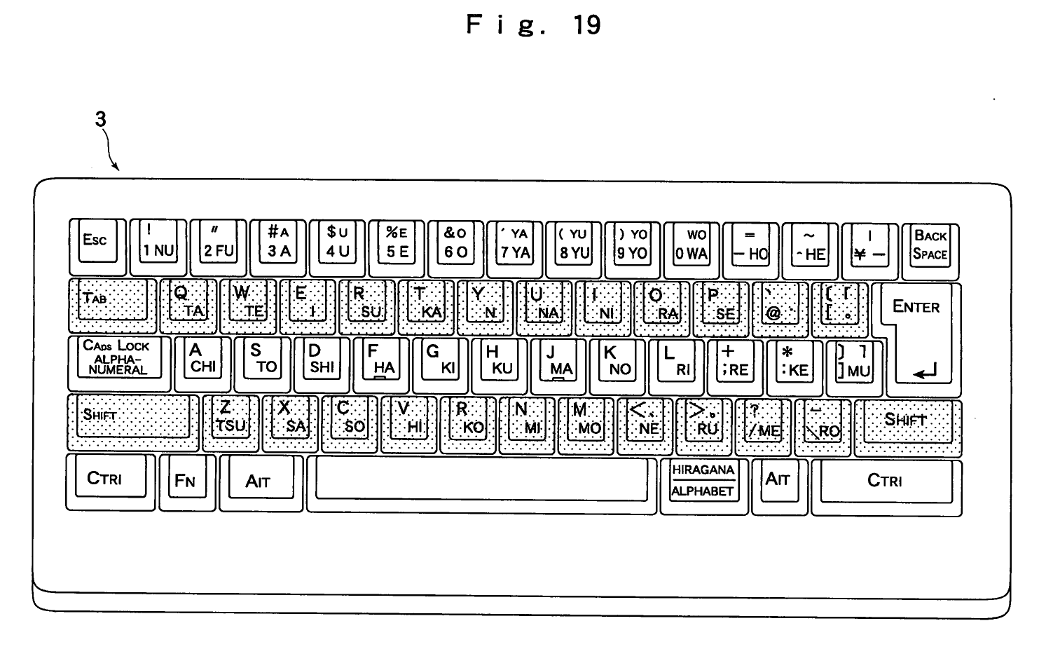

FIG. 19 is an emission mode example (1) of the keyboard when the commercial advertisement is being performed in the typing game according to the embodiment;

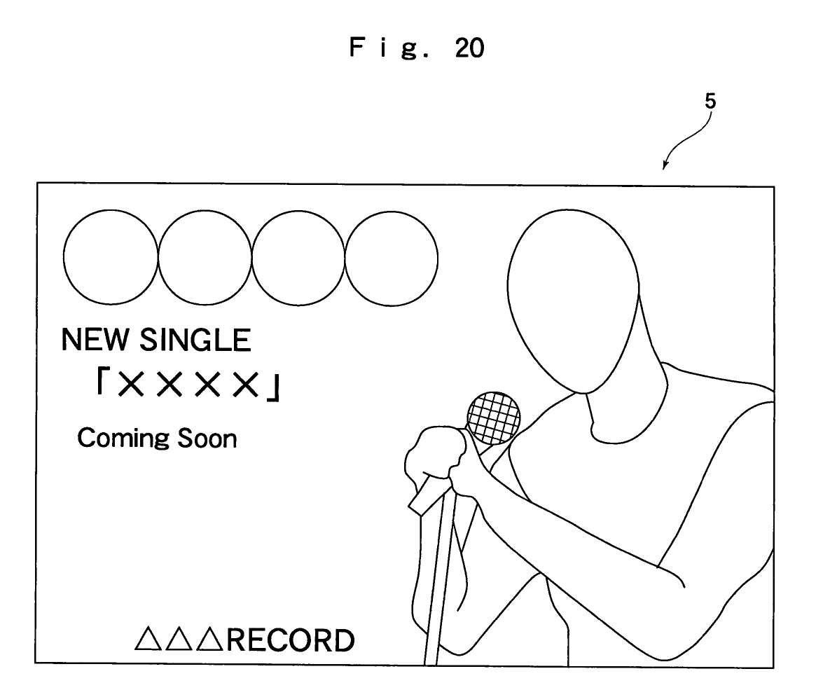

FIG. 20 is a display example (2) of the first liquid crystal display when the commercial advertisement is being performed in the typing game according to the embodiment; and

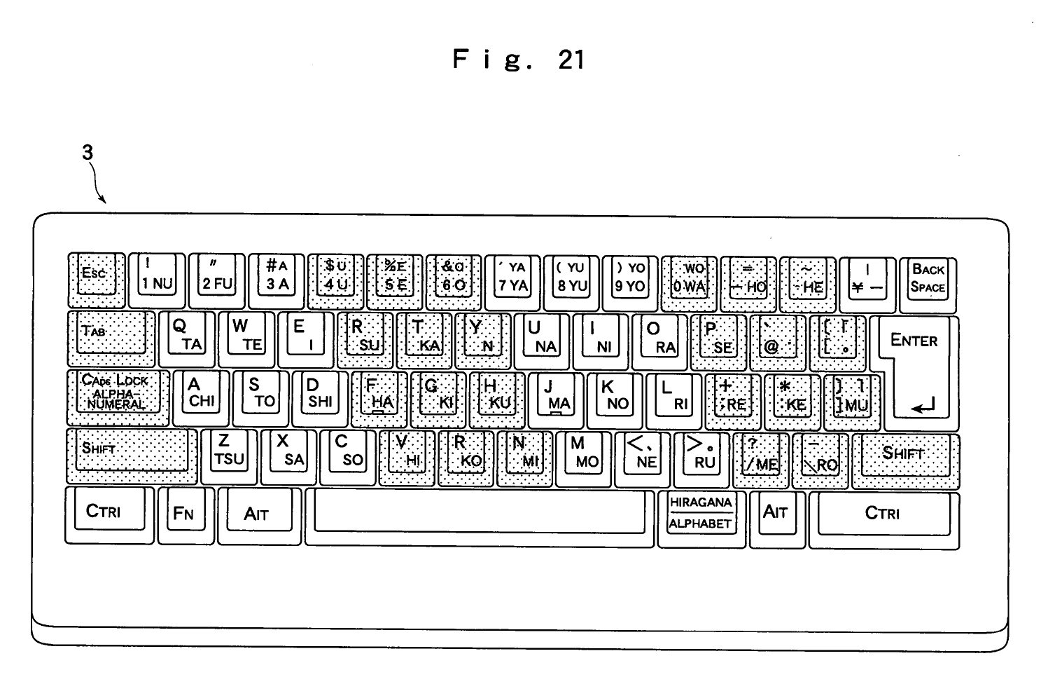

FIG. 21 is an emission mode example (2) of the keyboard when the commercial advertisement is being performed in the typing game according to the embodiment.

### DESCRIPTION OF THE PREFERRED EMBODIMENT

A typing game apparatus of the embodiment, on which a typing game progresses by inputting the lyrics of a song while listening to the song, comprises: a image display (e.g., a first liquid crystal display 4, a second liquid crystal display 5) capable of displaying a character string to be input and an image during a typing game; an input device (e.g., a keyboard 3) for inputting the character string; a sound production section (e.g., a speaker 7) for producing a sound based on music data; an illumination section (e.g., an external illumination LED 6) for performing a turning on and off effect; a communication section (e.g., a game communication section 25) which receives effect data, which includes image data, music data (e.g., performance data), and emission control data defining the emission mode of the illumination section, from a server (e.g., a server 80) having a database which stores the effect data; and a CPU (e.g., a CPU 10) which displays a predetermined image on the image display, based on the effect data, when an input operation using the input device has not been performed for a predetermined time period, and which controls the emission mode of the illumination section based on the emission control data.

Thus, when an input operation using the input device has not been performed for a predetermined time period, i.e., when no typing game is being performed, image data can be displayed on a image display based on effect data which includes image data, music data, and emission control data defining the emission mode of an illumination section, a sound can be produced by a sound production section based on music data, and the emission mode of the illumination section can be controlled based on emission control data. An effect corresponding to the effect data is thereby performed by the image display and the illumination section, thereby making it possible to attract a spectator's interest even when no typing game is being performed.

Furthermore, effect data, which includes image data, music data, and emission control data defining the emission mode of the illumination section, can be distributed to the typing game apparatus from the server via the communication section. Therefore, it becomes possible to perform an effect in a new mode based on new effect data when appropriate, which therefore makes is possible to always perform an effect full of freshness. In other words, it is possible to reduce the degree of a decrease in the effect of attracting the spectator's interest.

The configuration can be such that the image display can be configured to include: a first image display (e.g., the first liquid crystal display 4) for displaying the character string; and a second image display (e.g., the second liquid crystal display 5) for displaying a predetermined image based on the image data, and such that the effect data includes: song data (e.g., FIG. 6A) which includes image data, music data, emission control data, and lyrics data, and which is used in conjunction with the typing game; and advertisement data (e.g., FIG. 6B) for use in a commercial advertisement, which includes image data, music data, and emission control data.

With such a configuration, image data of the advertisement data is displayed on the second image display which is separate from the first image display on which a typing game is performed. Therefore, this enables more powerful image representation for a commercial advertisement. Accordingly, even when no typing game is being performed, it is possible to further increase the effect of attracting the spectator's interest.

In the typing game apparatus (e.g., the typing game apparatus 1), upon reception of the advertisement data (e.g., image data, performance data, sound data, and LED emission pattern data in FIG. 6B) from the server (e.g., the server 80) through the communication section (e.g., the game communication section 25), the CPU (e.g., the CPU 10) displays an image of an advertisement on the second image display (e.g., the second liquid crystal display 5) based on the image data, produces a sound through the sound production section (e.g., the speaker 7) based on the music data, and controls the emission mode of the illumination section (e.g., the external illumination LED 6) based on the emission control data.

With such a configuration, a spectator's interest is attracted to the advertisement data distributed from the server. Therefore, it is possible to strongly impress upon the spectator a product related to the advertisement data and thus increase an advertising effect.

Furthermore, the advertisement data can be distributed to the typing game apparatus through the communication section. Therefore, a timely advertisement can be performed, and the consumer interest of those who have seen the advertisement can be further aroused.

In the typing game apparatus (e.g., the typing game apparatus 1), upon reception of the song data (e.g., image data, performance data, sound data, and LED emission pattern data in FIG. 6A) from the server (e.g., the server 80) through the communication section (e.g., the game communication section 25), the CPU (e.g., the CPU 10) displays an image related to the song data to be used in a typing game, on the first image display (e.g., the first liquid crystal display 4), based on the image data of the song data, displays an image of a music advertisement corresponding to the song data on the second image display (e.g., the second liquid crystal display 5), produces a sound through the sound production section (e.g., the speaker 7) based on the music data of the song data, and controls the emission mode of the illumination section (e.g., the external illumination LED 6) based on the emission control data of the song data.

With such a configuration, song data, which includes image data, music data, and emission control data, can be received from the server via the communication section, an image regarding the song data can be displayed on the first image display, and the image data for a music advertisement corresponding to the song data can be displayed on the second image display. And, the sound of the music data of the song data can be produced by the sound production section, and the emission mode of the illumination section can be controlled based on the emission control data of the song data. Accordingly, a spectator's attention is aroused to a song related to song data, so that it is possible to strongly impress upon the spectator the song or an artist and a record company which are related to the song, and thus increase an advertising effect. Furthermore, the song data can be distributed to the typing game apparatus through the communication section, so that an advertisement regarding the latest song can be performed.

The configuration can be such that the input device is a keyboard (e.g., the keyboard 3) having a transparent keycap (e.g., a keycap 301) and an emission section (e.g., an LED 302) which emits light from below the keycap, wherein the keyboard also functions as part of the illumination section.

This makes it possible to perform an emission effect which uses the keyboard as part of the illumination section, so that a spectator's attention can be attracted to the typing game apparatus.

Accordingly, when an emission effect is performed based on advertisement data, the appeal of the advertisement can be increased. When an emission effect to a song is performed based on song data, it is possible to perform an effect which matches the mood of the song. Therefore, the player who executes a typing game can play the typing game while fully enjoying the song.

Furthermore, it is possible to construct a gaming system (e.g., a gaming system 100) comprising: the aforementioned typing game apparatus (e.g., the typing game apparatus 1); and a server (e.g., the server 80) including a song database (e.g., a song database 85a) having the song data (e.g., FIG. 6A) stored therein, an advertisement database (e.g., advertisement database 85b) having the advertisement data (e.g., FIG. 6B) stored therein, and a transmission section (e.g., a server communication section 83) which transmits both or any of the song data and the advertisement data to the typing game apparatus.

With such a gaming system, the song database and the advertisement database of the server are updated, whereby the latest song data and advertisement data can be distributed, when appropriate, to each typing game apparatus included in the gaming system.

Preferably, song data and advertisement data are distributed to the typing game apparatus when no typing game is being performed. The reason is that there is the possibility that an operation related to the execution of a typing game will become unstable when an access to the server is made during the execution of a typing game.

An embodiment in which is embodied a gaming system according to an aspect of the invention will hereafter be described in detail with reference to the drawings.

The configuration of the gaming system according to this embodiment will first be described with reference to the drawings. FIG. 1 is an illustration showing a configuration example of the gaming system of this embodiment.

A gaming system 100 according to an aspect of the invention includes a multiplicity of typing game apparatuses 1 and a server 80. These typing game apparatuses 1 and the server 80 are linked via a network N and thereby function as the gaming system 100 of this embodiment.

A game communication section 25 to be described later is included in each typing game apparatus 1, thus enabling two-way wireless communication between each typing game apparatus 1 and the server 80. A server communication section 83 to be described later is included in the server 80, so that data can be transmitted and received by wireless between the server 80 and each typing game apparatus 1.

The gaming system 100 of this embodiment is adapted such that the typing game apparatuses 1 and the server 80 are linked to the network N by wireless, and such that data is transmitted and received by wireless therebetween. However, the configuration need not be limited to wireless, but the typing game apparatuses 1 and the server 80 may be linked to the network N by wired connections.

A typing game system of this embodiment will now be described in detail with reference to FIGS. 2 to 4.

The outlined configuration of the typing game apparatus 1 will first be described with reference to FIG. 2. FIG. 2 is an exterior perspective view of the typing game apparatus 1.

On the typing game apparatus 1 of this embodiment, a typing game is performed by the method of inputting the lyrics of a song. When the typing game is started, the performance data of music accompanying the song and the sound data of the singing voice of an artist of the song are reproduced. Then, with the progress of the performance data and the sound data of the song, the lyrics of the song are displayed for each phrase in the form of character strings which a player is to input.

These displayed lyrics of one phrase are input from a keyboard 3, thereby allowing the typing game to progress. At the end of the song, the record of the typing game is calculated based on typing parameters such as typing accuracy and input timing. In other words, the typing game on the typing game apparatus 1 involves competing in the level of typing skills while enjoying a song played during the game.

As shown in FIG. 2, the typing game apparatus 1 of this embodiment includes the keyboard 3, a first liquid crystal display 4, a second liquid crystal display 5, and the like, which are disposed on a cabinet 2 serving as the main body of the typing game apparatus 1.

The first liquid crystal display 4 is disposed on the front of the cabinet 2 of the typing game apparatus 1. The first liquid crystal display 4, which is a so-called liquid crystal display, is tilted slightly backward relative to the front of the cabinet 2.

During the execution of a typing game, the first liquid crystal display 4 displays the lyrics data of a song reproduced, and performs a display related to the gameplay of the typing game, such as an input result which the player has obtained by inputting lyrics using the keyboard 3, and a score obtained in response to the input result.

In other words, the first liquid crystal display 4 of this embodiment corresponds to the first image display according to an aspect of the invention.

The second liquid crystal display 5 is located above the first liquid crystal display 4 on the cabinet 2. Similar to the first liquid crystal display 4, this second liquid crystal display 5 is a so-called liquid crystal display.

During the execution of a typing game, the second liquid crystal display 5 displays an image related to a song to be reproduced. For example, when a song of an artist is reproduced as the song, a promotional video (henceforth called a PV) related to the song of the artist is displayed on the second liquid crystal display 5.

When no typing game is being executed, the second liquid crystal display 5 displays a music advertisement (e.g., the demonstration play of a typing game or the demonstration play of a new song due to be distributed to a typing game apparatus) or a commercial advertisement (e.g., the advertisement of a new product). Accordingly, the second liquid crystal display 5 of this embodiment corresponds to the second image display according to an aspect of the invention.

Speakers 7 are located on both left and right sides of the second liquid crystal display 5. The speakers 7 are units which produce the sound of a song and the like on the typing game apparatus 1. During the execution of a typing game, the speakers 7 produce a sound based on the sound and performance data of a song to be reproduced. When no typing game is being executed, the speakers 7 produce a sound based on the sound data and the performance data related to a commercial advertisement.

External illumination LEDs 6 are located on both left and right sides of the cabinet 2, four on each side. These external illumination LEDs 6, consisting of full-color LEDs which can produce light in full color, perform a variety of illumination effects in response to a song and a commercial advertisement which are reproduced on the typing game apparatus 1. For example, it is possible to perform the effect of varying the illumination colors of a total of eight external illumination LEDs 6, the effect of varying the illumination colors in accordance with a fixed pattern, and the effect of turning on and off the external illumination LEDs 6.

A coin insertion slot 8 and a card insertion slot 9 are provided below the first liquid crystal display 4 disposed on the front of the cabinet 2. The coin insertion slot 8 is used for collecting coins as payment for the execution of a typing game on the typing game apparatus 1. A coin sensor 27, to be described later, disposed inside the coin insertion slot 8, detects a coin inserted, thereby enabling the execution of a typing game on the typing game apparatus 1.

The card insertion slot 9 is a portion into which is inserted a card (not shown) with a built-in IC chip for recording the game result of a typing game. A card sensor 28 and a card reader/writer 29, to be described later, are disposed inside this card insertion slot 9. Accordingly, when the IC chip card is inserted into the card insertion slot 9, the card sensor 28 detects the IC chip card, and the card reader/writer 29 reads and writes the game result of a typing game from the IC chip card.

The keyboard 3 is positioned projecting outward from the front of the cabinet 2. This keyboard 3, having arranged thereon a plurality of keys 300, such as keys of roman letters “A to Z”, kana letters “A to N”, numbers “0 to 9”, symbols such as a period and a comma, and an enter key, is a section for inputting letters, symbols, numbers, and the like using the corresponding keys. The keyboard 3 is also a command section for issuing a command, for example, to determine the selection of a song and a character kind, and to start the execution of a typing game.

Accordingly, at the time of execution of the typing game in the typing game apparatus 1, the game is allowed to proceed by entering the character string displayed on the first liquid crystal display 4 using the corresponding keys 300.

The configuration of the keyboard 3 will now be described. FIG. 3 is a schematic sectional view of any one of the plurality of keys 300 provided on the keyboard 3.

As shown in FIG. 3, the key 300 includes a substrate 310, a switch circuit board 311, a light emission circuit board 320, a keycap 301, a biasing mechanism 303, and the like.

The switch circuit board 311 laid on the substrate 310 is provided with a pair of electrodes 312 located under the center of the keycap 301.

The light emission circuit board 320 laid on the switch circuit board 311 is provided with an opening 322 for exposing the pair of electrodes 312. LEDs 302 capable of producing light in full color are provided around the opening 322.

The biasing mechanism 303, provided between the light emission circuit board 320 and the keycap 301, biases the keycap 301 away from the switch circuit board 311. Furthermore, an electrode 301b projects from the center of the keycap 301 towards the switch circuit board 311. Accordingly, when the keycap 301 is depressed, the electrode 301b projecting from the keycap 301 can be brought into contact with the pair of electrodes 312 provided on the switch circuit board 311. Therefore, the depression of the keycap 301 can be transmitted as an electrical signal flowing through the switch circuit board 311. These three electrodes 301b and 312 thus constitute a key switch 330.

The biasing mechanism 303 may be configured of only an elastic body, or may be configured of an elastic body and a cross-linking mechanism. It doesn't matter what configuration the biasing mechanism 303 takes.

The keycap 301 is formed of a transparent material (e.g., transparent acryl or transparent plastic), and key information 301a, such as a letter, a number, or a symbol, is printed in black on the flat portion of the keycap 301 opposite the switch circuit board 311. Furthermore, the surface of the light emission circuit board 320 on the keycap 301 side is also printed black.

Accordingly, when the LEDs 302 are off, the transparent keycap 301 is reflected in black which is the color of the surface of the light emission circuit board 320, which therefore makes it difficult to recognize the key information 301a printed in black on the keycap 301.

Conversely, when the LEDs 302 are on, the transparent keycap 301 is reflected in the color in which the LEDs 302 are lit, which therefore makes it easy to recognize the key information 301a printed in black on the keycap 301 reflected in that color.

In the keyboard 3, the key switch 330 inside each key 300 is connected to a transmission circuit (not shown). The transmission circuit is connected to a CPU 10 of the typing game apparatus 1 via an interface unit 26 (henceforth called an I/O) to be described later. Accordingly, an electrical signal from the key switch 330 of a key 300 depressed is transmitted to the CPU 10 via this transmission circuit, and the key 300 depressed can thereby be identified. The transmission circuit is mounted on the switch circuit board 311.

Additionally, in the keyboard 3, the LEDs 302 inside each key 300 are connected to a light emission control section 24. Furthermore, the light emission control section 24 is connected to the CPU 10 via the I/O 26. Accordingly, via this light emission control section 24, the LEDs 302 inside this key 300 can be lit in a specified color.

FIG. 3 illustrates one key 300, but the other keys 300 arranged on the keyboard 3 also have the same configuration and function.

The control system of the typing game apparatus 1 will now be described in detail with reference to the drawings. FIG. 4 is a block diagram of the control system of the typing game apparatus 1.

As shown in FIG. 4, the control system of the typing game apparatus 1 includes the CPU 10 in charge of various controls, such as a game processing operation on the typing game apparatus 1, and a peripheral device (actuator) electrically connected to this CPU 10.

The CPU 10 is a central processing unit which performs calculation in accordance with a variety of commands. The I/O 26 is a connection which provides a direct/indirect electrical connection between the CPU 10 and the keyboard 3, the first liquid crystal display 4, the second liquid crystal display 5, the speakers 7, and the like. A ROM 14 is a nonvolatile read-only memory which stores a calculation program for actuating flowcharts to be described later. A RAM 21 is a volatile read or write memory for temporarily storing data to be used when the CPU 10 executes a program, and temporarily storing song data stored in an HDD 20.

The HDD 20 is a storage device which stores song data and advertisement data. The song data stored in this HDD 20 is used in executing a typing game on the typing game apparatus 1, and when no typing game is being executed by the player, in performing a so-called demonstration play to show a typing game being executed.

The advertisement data is used, when no typing game is being executed, in performing an advertisement instead of the demonstration play.

Accordingly, the HDD 20 is formed with a song data storage area 20a which stores plural pieces of song data and an advertisement data storage area 20b which stores plural pieces of advertisement data.

The song and advertisement data stored in the HDD 20 will now be described in detail with reference to the drawings. FIG. 6A is an illustration of the song data, and FIG. 6B is an illustration of the advertisement data.

The song data will first be described with reference to FIG. 6A. As shown in FIG. 6A, the song data for use in the typing game apparatus 1 includes image data, performance data, sound data, lyrics data, determination reference data, LED emission pattern data, keyboard emission pattern data, and use period data.

In the typing game apparatus 1 of this embodiment, since a typing game is performed by inputting the lyrics of a song being sung by an artist as the song is reproduced, the aforementioned pieces of data included in the song data correspond to such a song.

In other words, the image data contained in the song data is data on a PV image of an artist corresponding to the song, the performance data is music data on the accompaniment of a musical instrument or the like to the song, and the sound data is sound data on the singing voice of an artist singing the song.

The lyrics data contained in the song data, which is text data on lyrics corresponding to each song, is used in displaying the lyrics of each phrase on the first liquid crystal display 4 during the execution of a typing game or a demonstration play.

The song data also includes song data which allows a typing game to be performed until the end of the song, as well as song data (called to-be-distributed song data) containing the list of songs due to be distributed shortly from the server 80.

As described above, the demonstration play is performed when no typing game is being executed. On this occasion, the song data which allows a game to be performed until the end of the song and the to-be-distributed song data are used out of the song data storage area 20a. Therefore, the typing game apparatus 1 can impress a spectator and also functions as a music advertisement for a song being used in the demonstration play.

For example, when the demonstration play is executed using the to-be-distributed song data, the spectator can be notified of a song to which a game can soon be performed on the typing game machine 1, which can therefore increase a spectator's expectations of the typing game apparatus 1.

Furthermore, a song from the to-be-distributed song data is often the latest song or a song scheduled to be released shortly and therefore functions as a music advertisement for its CD, which can motivate the spectator to buy the CD of the latest song or a new song scheduled to be released.

The determination reference data contained in the song data is reference data which is used for determining the accuracy of an input made by the player using the keys 300 and the accuracy of input timing during the execution of the typing game using the song data.

When the player has typed according to the reference of the determination reference data, he/she is granted a high score. Conversely, when the keys 300 which the player has used for an input differ from the keys 300 defined by the determination reference data (in the case of so-called mistyping), or when the key input timing differs from the reference of the determination reference data, such as falling substantially behind the progress of a song, a high score cannot be obtained at the end of the typing game.

The LED emission pattern data and the keyboard emission pattern data, contained in the song data, are effect data which define the modes of illumination effects on the typing game apparatus 1 during the execution of the typing game using the song data.

In other words, the LED emission pattern data is data on the emission pattern of external illumination LEDs 6 which emit light according to the progress of a song. Accordingly, the emission modes of the external illumination LEDs 6 are defined based on this LED emission pattern data, and the light emission control section 24 to be described later controls the emission modes (e.g., light color and turning on and off) of each of eight external illumination LEDs 6.

The keyboard emission pattern data is data on the emission patterns of the LEDs 302 contained in each of the keys 300 arranged on the keyboard 3. Accordingly, the emission modes of the LEDs 302 in each key 300 arranged on the keyboard 3 are controlled via the light emission control section 24 based on the keyboard emission pattern data.

As the emission patterns of the keyboard 3, the following emission patterns are provided for a novice player of a typing game: an emission pattern in which keys with which an input should be made are sequentially turned on in an emission color different from that of the entire keyboard 3, thereby assisting in the key input; and an emission pattern in which the emission color of all the keys 300 arranged on the keyboard 3 is varied in accordance with the mood of a song.

The use period data, which is data on the use period of the song data, consists of two pieces of date data on: the date (use start date) on which the song data becomes usable and the date (use end date) on which the song data becomes unusable. The date data on the use start date of the song data is called use period start data, and the date data on the use end date of the song data is called use period end data. These pieces of use period data are used to manage the use period of each piece of song data.

The advertisement data stored in the advertisement data storage area 20b of the HDD 20 will now be described with reference to FIG. 6B. The advertisement data used on the typing game apparatus 1 includes image data, performance data, sound data, LED emission pattern data, keyboard emission pattern data, and use period data.

When no typing game is being executed, the typing game apparatus 1 of this embodiment performs the so-called demonstration play, which shows a typing game being executed, or a commercial advertisement such as are being broadcast on television or the like. The advertisement data stored in the advertisement data storage area 20b is data to be used in performing a commercial advertisement when no typing game is being executed.

This advertisement data contains plural pieces of advertisement data having different contents. For example, a piece of advertisement data may be advertisement data on a new product of company A, and another piece of advertisement data may be advertisement data on the CD of a new song by an artist X. A plurality of such pieces of advertisement data are stored in the advertisement data storage area 20b.

Accordingly, in the case in which a commercial advertisement is performed when no typing game is being executed, the commercial advertisement is performed using one of the plurality of pieces of advertisement data stored in the advertisement data storage area 20b. Therefore, the advertisement for the CD of the new song by the artist X may be performed on one occasion, and the advertisement for the new product of company A may be performed on another occasion.

When no typing game is being executed, a wide variety of commercial advertisements including music advertisements are also performed in this way on the typing game apparatus 1, which can therefore motivate the spectator to buy an advertisement target related to the advertisement data. In particular, the typing game apparatus 1 is a gaming apparatus on which a typing game is performed using a song, which, in this case, can therefore increase the appeal effectiveness of the music advertisement (e.g., the advertisement for the CD of a new song).

As described above, an advertisement content is defined in each piece of advertisement data. Accordingly, each piece of advertisement data contains image data, performance data, sound data, LED emission pattern data, keyboard emission pattern data, and use period data which are used in performing such an advertisement and are based on such advertisement content.

In other words, the image data contained in the advertisement data is data on an image corresponding to the advertisement content of such a commercial advertisement, and may be data on, for example, a commercial image such as is being broadcast on television. Furthermore, in the case of the advertisement for the CD of a new song by an artist, the advertisement data may be data on a commercial image such as is being broadcast on television, or may also be image data on a PV image. The performance data is music data on an accompaniment on a musical instrument or the like, which is used as background music in such a commercial advertisement, and the sound data is sound data on a narration or the like in a commercial advertisement.

The LED emission pattern data and the keyboard emission pattern data, contained in the advertisement data, are effect data which define the modes of illumination effects on the typing game apparatus 1 when a commercial advertisement is performed using such advertisement data.

In other words, the LED emission pattern data is data on the emission patterns of the external illumination LEDs 6 which are used when a commercial advertisement is being performed. Accordingly, the emission patterns of the external illumination LEDs 6 are set based on this LED emission pattern data, and the light emission control section 24, to be described later, controls the emission modes of the eight external illumination LEDs 6 (e.g., light color and turning on and off). The illumination effects using the external illumination LEDs 6, which correspond to respective pieces of advertisement data, are thereby performed, which can therefore further increase the appeal effectiveness of a commercial advertisement.

The keyboard emission pattern data is data on the emission patterns of the LEDs 302 disposed in each of the keys 300 arranged on the keyboard 3. Accordingly, the emission modes of the LEDs 302 in each key 300 arranged on the keyboard 3 are controlled based on the keyboard emission pattern data via the light emission control section 24.

The LED emission pattern data and the keyboard emission pattern data are thus set for each piece of advertisement data, which can therefore create an atmosphere corresponding to each commercial advertisement and which can thus attract attention to the commercial advertisement. Accordingly, a commercial advertisement of higher appeal effectiveness can be performed as compared with the case in which an advertisement is simply displayed.

Referring again to FIG. 4, the control system of the typing game apparatus 1 will now be described.

The game communication section 25 is a device which converts a signal to be sent from the typing game apparatus 1 into a communicable signal appropriate to a communication form, such as a telephone line or a LAN cable, and transmits the converted signal externally, and which receives a signal transmitted and reconverts the received signal into a signal readable to the typing game apparatus 1. The game communication section 25 is linked to the network N by wireless and to the server communication section 83 of the server 80 via this network N.

The HDD 20 is a storage device which has the song data storage area 20a for storing song data received from the server 80 and the advertisement data storage area 20b.

A display control section 22, connected to the CPU 10 via the I/O 26, is a portion which is used to control the display contents of the first and second liquid crystal displays 4 and 5 in response to the computation result of the CPU 10. In other words, when a typing game is being executed, the display control section 22 displays the lyrics data, contained in the song data, for each phrase on the first liquid crystal display 4. Besides, the display control section 22 is also used to exert control such as, based on the result of an input made from the keyboard 3, displaying the characters which correspond to the content of such an input on the first liquid crystal display 4.

The display control section 22 is also used to display various effect images on the second liquid crystal display 5. In the typing game apparatus 1 of this embodiment, during the execution of a typing game, a PV contained in the image data contained in the song data is displayed on the second liquid crystal display 5, while, when no typing game is being executed, an image related to a commercial advertisement is displayed on the second liquid crystal display 5. Therefore, the display control section 22 is also used to exert control over the display of images related to such song and advertisement data on the second liquid crystal display 5.

A sound control section 23 is connected via the I/O 26 to the CPU 10 and also to the speakers 7. When song data is read during the execution of a typing game, the performance data and the sound data, contained in the song data, are converted into sound signals by the sound control section 23, and the sound signals are output from the speakers 7. In no execution of the typing game, in performing a music advertisement (e.g., the demonstration play of a typing game) using song data, or in performing a commercial advertisement using advertisement data, the corresponding performance or sound data is converted into a sound signal by the sound control section 23, and the sound signal is output from the speakers 7.

The light emission control section 24 is connected via the I/O 26 to the CPU 10 and to the external illumination LEDs 6 as well as to the LEDs 302 disposed in each key 300 arranged on the keyboard 3. The light emission control section 24 is used, when song data is read during the execution of a typing game, to control the emission modes of the external illumination LEDs 6 and the LEDs 302 based on the LED emission pattern data and the keyboard emission pattern data which are contained in the song data. Besides, the light emission control section 24 is also used, when no typing game is being executed, to control the emission modes of the external illumination LEDs 6 and the LEDs 302 based on the song data used in the music advertisement (e.g., the demonstration play of a typing game) and the LED emission pattern data and the keyboard emission pattern data which correspond to the advertisement data of a commercial advertisement.

The coin sensor 27 is a sensor which detects a coin used as payment for the execution of a typing game on the typing game apparatus 1. The coin sensor 27, disposed inside the coin insertion slot 8, is connected to the CPU 10 via the I/O 26. Accordingly, the coin sensor 27 transmits a coin insertion signal to the CPU 10 based on the insertion of a coin from the coin insertion slot 8. The CPU 10 detects the coin insertion signal equivalent to a predetermined number of coins and thereby makes it possible to execute the typing game.

The card sensor 28 is a sensor which detects whether or not the IC chip card has been inserted in the card insertion slot 9, and the card reader/writer 29 is a unit which reads and writes data to the IC chip disposed in this IC chip card. The card sensor 28 and the card reader/writer 29, both disposed inside the card insertion slot 9, are connected to the CPU 10 via the I/O 26. When the card sensor 28 recognizes that the IC chip card has been inserted, the CPU 10 reads data from the IC chip or writes data to the IC chip via the card reader/writer 29.

A timer 30, which is a timing section, is connected to the CPU 10 via the I/O 26. The timer 30 is used to determine when no typing game is being executed on the typing game apparatus 1. In other words, the timer 30, which times a period of time during which no operation is being performed on the typing game apparatus 1, is used, when the period of time during which no operation is being performed exceeds a predetermined period of time, to determine that no typing game is being performed and to thereafter move the process to a demonstration effect process which performs a demonstration play or a commercial advertisement.

A detailed description will now be given of the functions of the ROM 14 which actuates flowcharts to be described later. The ROM 14 includes an initialization section 15, an accuracy determination section 17, a timing determination section 18, and a score determination section 19.

The initialization section 15, having a song selection section 15a, is used, at the start of a game, to set the content of the game. In other words, in this embodiment, the initialization section 15 is used to select song data to be used in a typing game from plural pieces of song data, which are stored in the song data storage area 20a, and to change the game setting (e.g., the level of game difficulty) of the typing game.

The song selection section 15a is used to lead the player to select a song title, to read song data, which corresponds to the song title selected by the player from the HDD 20, and to temporarily store the song data in the RAM 21. More specifically, the CPU 10 uses the song selection section 15a, thereby displaying a song selection screen on the first liquid crystal display 4. The song selection screen displays the names of artists and the titles of the songs by the artists. Accordingly, the player selects a desired song using the keyboard 3, whereby song data corresponding to the desired song is read from the HDD 20 and stored in the RAM 21. The song data thus stored in the RAM 21 is sequentially reproduced on the first liquid crystal display 4, the second liquid crystal display 5, and the speakers 7, thereby executing a typing game based on the desired song.

The accuracy determination section 17 is used to compare input information, which corresponds to characters included in a character string displayed on the first liquid crystal display 4, and the determination reference data of a corresponding song, and to thereby determine whether or not a character to be currently input has been successfully typed.

The timing determination section 18 is used, based on the determination reference data, to determine whether or not the typing has been performed based on the progress of the song. In other words, the timing determination section 18 is used to determine whether or not the typing has been performed generally in synchronization with the singing voice of an artist in the song. In this embodiment, when the singing voice of the artist and the typing are in time with one another to some extent, it is determined that they are in time with one another.

The score determination section 19 is used to determine a player's game score based on the determination results of the accuracy determination section 17 and the timing determination section 18. More specifically, the score determination section 19 is used to determine a game score based on the accuracy (the presence or absence of so-called mistyping), timing error, and the like of typing during a typing game.

A description will now be given of the server 80 which distributes song data and advertisement data to the typing game apparatus 1 when appropriate.

The server 80 of this embodiment includes a server CPU 81, a server ROM 82, a server communication section 83, a server storage area 85, and a server timer 86.

The server CPU 81 is a central processing unit which controls various sections of the server 80 to execute a control program. Accordingly, the server CPU 81 executes a program for making lists of plural pieces of song data and plural pieces of advertisement data, which are stored in a song database 85a and an advertisement database 85b in the server storage area 85 to be described later, and for transmitting the data lists to the typing game apparatus 1, and a program for, based on a request from the typing game apparatus 1, transmitting the requested song data and advertisement data.

The server ROM 82 is a nonvolatile read-only memory which stores the control program for allowing the server CPU 81 to perform various control operations. Accordingly, the server ROM 82 stores various programs, such as a program for creating the data lists of the song data and the advertisement data in the song database 85a and the advertisement database 85b.

The server communication section 83 is a communication section which provides reciprocal communication between the server 80 and the typing game apparatus 1 via the network N. In other words, the server communication section 83 is a device which converts data transmitted from the server 80 into a communicable signal appropriate to a communication form, such as a telephone line or a LAN cable, and transmits the converted signal externally, and which receives a signal sent from the typing game apparatus 1 and reconverts the received signal into a signal of a form readable to the server 80. The server communication section 83 is linked by wireless to the game communication section 25 of the typing game apparatus 1 via the network N.

The server storage area 85 is a storage section which stores various data to be used in the server 80 and can add and delete the storage content. This server storage area 85 includes the aforementioned song database 85a which stores plural pieces of song data and the aforementioned advertisement database 85b which stores plural pieces of advertisement data. Accordingly, for example, the server storage area 85 can update the content of the advertisement database 85b when appropriate, such as by deleting outdated advertisement data in the advertisement database 85b or by adding new advertisement data.

This makes it possible to perform a commercial advertisement responsive to the distribution time of a commercial product and the season. Accordingly, seasonal advertisement data can be distributed, thus making it possible to perform a seasonal commercial advertisement on each typing game apparatus 1, which can therefore further display the appeal effectiveness of the commercial advertisement.

In addition, the server storage area 85 is also a storage section which temporarily stores various calculation results to execute the control program of the server 80.

The server timer 86, which is a timing section that records the date and hour, is used to create a data list based on data in the song database 85a and the advertisement database 85b.

The server timer 86 is connected to the server CPU 81. With reference to the current time, the server timer 86 determines the song data which has been most recently added to the song database 85a (henceforth called latest song data) and advertisement data which has been the most recently added to the advertisement database 85b (henceforth called latest advertisement data). The server timer 86 then added the latest song data and the latest advertisement data to the data list, and transmits them to the typing game apparatus 1. In other words, the server timer 86 is also used to specify the latest song data and the latest advertisement data from among the plural pieces of song data and the plural pieces of advertisement data which are stored in the song database 85a and the advertisement database 85b.

Additionally, in creating the data list, the server timer 86 is also used to refer to the current time of the server timer 86 and compare this current time with the use period data of the song data and the advertisement data, and thereby identify outdated song data and outdated advertisement data.

This server timer 86 is preferably always adjusted to the exact time, similar to a wave clock having the function of automatically correcting a time error.

The operation of the typing game apparatus 1 will now be described with reference to the drawings. A main control program of the typing game apparatus 1 will first be described with reference to FIG. 7. FIG. 7 is a flowchart of the main control program of the typing game apparatus 1.

As shown in FIG. 7, in the typing game apparatus 1 of this embodiment, when the typing game apparatus 1 is activated, a data update process (S1) is performed. The data update process (S1) is the process of deleting song data and advertisement data stored in the song data storage area 20a and the advertisement data storage area 20b of the typing game apparatus when the song and advertisement data have expired, and adding latest song data and latest advertisement data, which have been input to the server 80, to the song data storage area 20a and the advertisement data storage area 20b. This data update process (S1) will be described in detail later with reference to the drawings, and will therefore be omitted here from detailed description.

After the data update process (S1) ends, it is determined whether a key has been input or not (S2). In S2, such a determination is performed based on whether any of the keys 300 disposed on the keyboard 3 has been depressed or not. If any of the keys 300 is input (S2: YES), the process moves to a typing game process (S5).

Conversely, if none of the keys 300 disposed on the keyboard 3 have been input (S2: NO), the process moves to S3.

In S3, it is determined whether a predetermined time period has elapsed or not. This determination of S3 is performed based on a numeric value from the timer 30. The timer 30 starts timing at the end of the data update process (S1) or at the end of the typing game process (S5). If the predetermined time period has elapsed (S3: YES) as a result of referring to the value from the timer 30, the process moves to S4. Conversely, if the predetermined time period has not elapsed (S3: YES), the process returns to S2.

By thus passing through the processes of S2 and S3, in the typing game apparatus 1 of this embodiment, it is determined whether or not the time period during which no operation has been performed is a predetermined time period or longer. Accordingly, if it is determined in S3 that the predetermined time period has elapsed (S3: NO), it follows that the time period during which no operation has been performed is the predetermined time period or longer, and it can thus be determined that no typing game is being performed. Accordingly, in this case, the process moves to a demonstration effect (S4) to perform the demonstration play of a typing game and a commercial advertisement on the typing game apparatus 1.

In S4, the demonstration effect process is performed. Performed in the demonstration effect process (S4) are a music advertisement (e.g., a demonstration play showing a typing game being executed) based on the song data stored in the song data storage area 20a of the typing game apparatus 1, and a commercial advertisement based on the advertisement data stored in the advertisement data storage area 20b.

This demonstration effect process (S4) will be described in detail later with reference to the drawings, and will therefore be omitted here from detailed description.

In S5 to which the process moves in S2 if any of the keys 300 disposed on the keyboard 3 has been operated (S2: YES), the typing game process is performed. This typing game process (S5) is a process related to the aforementioned execution of a typing game. The typing game process will be described in detail later with reference to the drawings, and will therefore be omitted here from description.

After the typing game process (S5) ends, the process returns to S2 again. As described above, when the typing game process ends, timing by the timer 30 is initiated.

The main control program of the typing game apparatus 1 will now be described in detail with reference to the drawings.

The data update program (S1) to be performed when the main control program of the typing game apparatus 1 will first be described in detail with reference to FIGS. 8 to 11. FIG. 8 is a flowchart of a data update processing program.

When the typing game apparatus 1 is activated to start the data update process (S1), then in S11, the CPU 10 transmits, to the server 80, identification information identifying this typing game apparatus 1, as well as a data list request signal which requests a data list corresponding to this typing game apparatus 1.

Upon reception of the data list request signal and the identification information which have been transmitted from the typing game apparatus 1, the server CPU 81 stores the received identification information in the server storage area 85 and performs a data list creation process (S101).

In the data list creation process (S101), a data list corresponding to this typing game apparatus 1 is created. Specifically, song data in use (henceforth called in-use song data), which is stored in the song data storage area 20a of the typing game apparatus 1 having transmitted the data list request signal, and advertisement data in use (henceforth called in-use advertisement data), which is stored in the advertisement data storage area 20b, are read to create a data list including the in-use song data and the in-use advertisement data.

The server CPU 81 compares the use period end data of each of all the song data and all the advertisement data, which are stored in the song database 85a and the advertisement database 85b, with the current date and hour which are indicated by the server timer 86. This makes it possible to determine whether the use period of each piece of song and advertisement data has expired or not.

Next, the server CPU 81 reflects, in the data list, the determination results of the use periods of the song data and the advertisement data. This makes it possible to determine from the data list whether the use period of any of the in-use song data and the in-use advertisement data has expired or not.

Besides, the server CPU 81 compares the use period start date data of each of all the song data and all the advertisement data, which are stored in the song database 85a and the advertisement database 85b, with the current data and hour which are indicated by the server timer 86. The server CPU 81 can thereby identify the latest song and advertisement data, which have been the most recently added, from among all the song and advertisement data.

The server CPU 81 creates a data list having the latest song data and the latest advertisement data added to the aforementioned data list made up of the in-use song data and the in-use advertisement data.

The data list thus created is a data list which includes the in-use song data, the in-use advertisement data, the latest song data, and the latest advertisement data, and which includes the determination result related to the use period expiration of each piece of data. After the data list has been created, the data list creation process (S10) is brought to an end, and the process then moves to S1102.

And, based on the identification information stored in the server storage area 85, the server CPU 81 transmits the data list created in the data list creation process (S101) to this typing game apparatus 1 via the server communication section 83 (S102).

Upon reception of the data list transmitted from the server 80, the CPU 10 stores the received data list in the RAM 21 and then moves the process to S12. In S12, a data use period management process is performed.

The data use period management process (S12) will now be described in detail with reference to the drawings. FIG. 9 is a flowchart of a data use period management processing program. FIG. 10 is an illustration showing a specific example of the data use period management process.

When the process moves to the data use period management process (S12), first, the CPU 10 compares the data list stored in the RAM 21 with the storage contents of the song data storage area 20a and the advertisement data storage area 20b (S2 1).

As described above, in the data list, the in-use song data and the in-use advertisement data, being used by the typing game apparatus 1, have already had their use period expiration determined. By comparing this data list with the storage contents of the song data storage area 20a and the advertisement data storage area 20b, it can be determined whether the use periods of each piece of song data and each piece of advertisement data, which are currently stored in the song data storage area 20a and the advertisement data storage area 20b, have expired or not, i.e., whether each piece of song data and each piece of advertisement data are expired data or not.

Furthermore, the data list includes the latest song data and the latest advertisement data. Therefore, by comparing this data list with the storage contents of the song data storage area 20a and the advertisement data storage area 20b, it can also be determined whether or not the latest song data and the latest advertisement data are contained in the song data and the advertisement data which are currently being used by the typing game apparatus 1.

By comparing the data list with the storage contents of the song data storage area 20a and the advertisement data storage area 20b, the use period of each piece of data is determined, and it is determined whether the latest song data and the latest advertisement data are stored therein or not. The process thereafter moves to S22.

In S22, it is determined whether or not any expired data exists in the song data stored in the song data storage area 20a of the typing game apparatus 1 and the advertisement data stored in the advertisement data storage area 20b. Accordingly, in S22, the determination is performed based on the process result of S21 in which the storage contents of the typing game apparatus 1 have been compared with the data list.

If any expired data exists in the song data storage area 20a and the advertisement data storage area 20b (S22: YES), the process moves to S23 to delete the expired data from the song data storage area 20a or the advertisement data storage area 20b. After all the song and advertisement data determined to have expired have been deleted in S21, the data use period management process (S12) is brought to an end. Conversely, if no expired data exists (S22: NO), the data use period management process (S12) is directly brought to an end.

The aforementioned process of S21 to S23 will now be described in accordance with the specific example of FIG. 10. In this specific example, song data (A), song data (B), and song data (C) are stored in the song data storage area 20a of the typing game apparatus 1, and advertisement data (1), advertisement data (2), and advertisement data (3) are stored in the advertisement data storage area 20b (see FIG. 10).

The data list created in the data list creation process (S101) is a data list regarding song data (A) to song data (E) and advertisement data (1) to advertisement data (5) (see FIG. 10).

Accordingly, song data (A) to song data (C) correspond to the in-use song data, and advertisement data (1) to advertisement data (3) correspond to the in-use advertisement data. Song data (D) and song data (E) are the latest song data, and advertisement data (4) and advertisement data (5) are the latest advertisement data.

Besides, as described above, in the data list, the result of the determination as to whether the use period of each piece of data has expired or not, i.e., whether the data is expired data or not is related to each piece of data. In FIG. 10, expired data is indicated by “x”, and data which continues to be usable is indicated by “O”. Therefore, in this specific example, song data (A), advertisement data (1), and advertisement data (2) are the expired data.

To describe the process of S21 to S23 in this situation, by comparing the data list with the storage content on the typing game apparatus 1 side, it is first determined that song data (A), advertisement data (1) and advertisement data (2), which are the expired data, exist in the song data storage area 20a and the advertisement data storage area 20b of the typing game apparatus 1 (S21).

As a result thereof, since expired data exists in the song data storage area 20a and the advertisement data storage area 20b (S22: YES), song data (A), advertisement data (1), advertisement data (2), which are the expired data, are deleted from the song data storage area 20a and the advertisement data storage area 20b. After the expired data has been deleted, the data use period management process (S12) is brought to an end, the process returns to the data update processing program.

Accordingly, at this point, song data (B) and song data (C) are stored in the song data storage area 20a, and advertisement data (3) is stored in the advertisement data storage area 20b.

Since the expired data is thus deleted, for example, in the case of advertisement data, after the distribution period of a commercial product expires, the commercial advertisement for the commercial product is prevented from being performed. Accordingly, it is possible to render available a storage area which had been occupied by advertisement data having low appeal effectiveness, which can thus effectively use the limited storage areas.

To return to the data update processing program, it will now be described with reference to FIG. 8. After the data use period management process (S12) is executed as described above, the CPU 10 determines whether data to be downloaded exists or not (S13). As used herein, the term data to be downloaded refers to song data and advertisement data which do not exist in the song data storage area 20a or the advertisement data storage area 20b and which are listed in the data list. The expired data is not included in this data to be downloaded.

Accordingly, in S13, a determination is performed based on the result of the comparison of the data list with the storage content of the typing game apparatus 1 in S21 in the data use period management processing program. If data to be downloaded exists (S13: YES), the process moves to S14, wherein a download request signal and an identification signal identifying this typing game apparatus 1 are transmitted to the server 80 so as to download the data to be downloaded from the server 80 (S14).

Conversely, if no data to be downloaded exists (S14: NO), the data update process (S1) is directly brought to an end.

Upon reception of the identification signal and the download request signal which have been transmitted from the typing game apparatus 1, the server CPU 81 stores the identification signal in the server storage area 85. And, based on the download request signal received, the server CPU 81 reads song data and advertisement data, which correspond to the data to be downloaded, from the song database 85a and the advertisement database 85b. At the same time, based on the identification signal stored in the server storage area 85, the server CPU 81 transmits the data to be downloaded via the server communication section 83 (S1103).

Upon reception of the requested data to be downloaded, the CPU 10 stores the data downloaded in a storage area (the song data storage area 20a or the advertisement data storage area 20b) corresponding to the kind of the data to be downloaded (song data, advertising data). After the data to be downloaded has been received and stored in the HDD 20, the data update process (S1) is brought to an end.

The process of S13 to S14 on the typing game apparatus 1 and the process of S103 on the server 80 will now be described in accordance with the aforementioned specific example and with reference to the drawings. FIG. 11 is an illustration of the process of S13 and subsequent steps in the case of the aforementioned specific example.

In the aforementioned specific example, when the data use expiration management process (S12) ends, in the typing game apparatus 1, song data (B) and song data (C) are stored in the song data storage area 20a, and advertisement data (3) is stored in the advertisement data storage area 20b.

When the process moves to S13, it is determined, from the result of the comparison of the storage content and the data list in S2 1, that song data (D) and song data (E), which are the latest song data, as well as advertisement data (4) and advertisement data (5), which are the latest advertisement data, are data to be downloaded.

In this case, since data to be downloaded exists (S13: YES), the process moves to S14, wherein the download request signals and the identification signals of song data (D), song data (E), advertisement data (4), and advertisement data (5), which are the data to be downloaded, are transmitted to the server 80 (S14).

The server CPU 81, which has received the download request signals, stores the identification signals in the server storage area 85, and reads song data (D) and song data (E) from the song database 85a, and advertisement data (4) and advertisement data (5) from the advertisement database 85b. And, based on the identification information, the server CPU 81 transmits song data (D), song data (E), advertisement data (4), and advertisement data (5), which it has read, to the typing game apparatus 1.

The CPU 10, which has received the data to be downloaded from the server 80, stores song data (D) and song data (E) in the song data storage area 20a, and advertisement data (4) and advertisement data (5) in the advertisement data storage area 20b. The CPU 10 thereafter brings the data update process (S1) to an end.

At this point, as shown in FIG. 11, in the song data storage area 20a and the advertisement data storage area 20b, song data (B), song data (C), song data (D), and song data (E) are stored in the song data storage area 20a, and advertisement data (3), advertisement data (4), and advertisement data (5) are stored in the advertisement data storage area 20b.

The typing game process (S5) will now be described in detail with reference to the drawings. FIG. 12 is a flowchart of a typing game processing program.

When the process moves to the typing game process (S5), first, in S31, it is determined whether the IC chip card is present or not. In other words, based on the detection result of the card sensor 28 disposed inside the card insertion slot 9, it is determined whether or not the IC chip card is inserted in the card insertion slot 9. If the IC chip card is present in the card insertion slot 9 (S31: YES), the process moves to S32. Conversely, if the IC chip card is absent from the card insertion slot 9 (S31: NO), the process moves to a start reception process (S34).

If the IC chip card is inserted in the card insertion slot 9 (S31: YES), then in S32, a display which asks “whether to confirm a storage content stored in the IC chip”, thus determining whether a data content is to be confirmed or not (S32).

If the player has selected the confirmation of the storage content of the IC chip card using the keyboard 3 (S32: YES), the storage content of the IC chip is read via the card reader/writer 29 and displayed on the first liquid crystal display 4 (S33). After the storage content of the IC chip is thus displayed, the process moves to the start reception process (S34). Conversely, if the player has selected no confirmation of the storage content of the IC chip card using the keyboard 3 (S32: NO), the process moves directly to the start reception process (S34).

In the start reception process (S34), a process related to the start of the execution of a typing game is performed, such as the initialization of the storage content of the RAM 21, the process of receiving coins to be used as payment for the execution of the typing game, and environmental game setting such as selection of the difficulty level of the typing game.

After the start reception process (S34) ends, a song selection process (S35) is performed. Performed in the song selection process (S35) is the process of selecting song data to be used in the current typing game from among the song data stored in the song data storage area 20a. Specifically, the song titles of all the pieces of song data stored in the song data storage area 20a are displayed on the first liquid crystal display 4. The player thus selects a song using the keyboard 3, thereby determining the song data to be used in the current typing game.

To give a description using the aforementioned example, in the song selection process, four song titles representing “song data (B)”, “song data (C)”, “song data (D)”, and “song data (E)” are displayed on the first liquid crystal display 4. A song to be used in the current typing game is then selected and thus determined as the song to be used from among these song titles using the keyboard 3.

After the song to be used in the typing game has been determined in the song selection process (S35), the process moves to a typing game execution process (S36). This typing game execution process (S36), which is a process related to the progress of a typing game, will be described in detail later, and will therefore be omitted here from description. After the typing game execution process (S36) ends, the process moves to S37.

In S37, a game result display process is performed in which the game result of a typing game is displayed on the first liquid crystal display 4. In the game result display process, a game result is displayed which is calculated based on factors, such as mistyping in the typing game performed in the typing game execution process (S36) and the synchronicity of typing with the determination reference data included in the song data.

After the game result display process (S37), in S38, it is determined whether or not the IC chip card is inserted in the card insertion slot 9. If the IC chip card is inserted in the card insertion slot 9 (S38: YES), the game result of the current typing game is recorded in the IC chip via the card reader/writer 29 (S39). After the game result has been recorded in the IC chip, the typing game process (S5) is brought to an end.

Conversely, if the IC chip card is not inserted in the card insertion slot 9 (S38): NO), the current game result is not recorded in the IC chip but deleted from the RAM 21, and the typing game process (S5) is then brought to an end.

The typing game execution process executed in S36 in the typing game process (S5) will now be described in detail in accordance with the drawings. FIG. 13 is a flowchart of a typing game execution processing program. FIGS. 14A and 14B are illustrations showing a display example on each liquid crystal display during a typing game, and FIG. 15 is an illustration showing the state of the keyboard 3 during the execution of a typing game.

As shown in FIG. 13, when the typing game execution processing program is executed, first, in S41, the song data selected in the song selection process (S35) is read from the song data storage area 20a (S41).

The reproduction of image data, sound data, and performance data which are included in the song data read is then started (S42). At this point, an image from the image data related to the PV of a song is displayed on the second liquid crystal display 5 (see FIG. 14A), and the sounds of the sound data and the performance data are produced from the speakers 7. Besides, based on the song data, a game screen related to the typing game is displayed as an image on the first liquid crystal display 4 (see FIG. 14B).

When the reproduction of image data, sound data, and performance data which are included in the song data has been initiated, one phrase which is a part of the lyrics data included in this song data is displayed on the first liquid crystal display 4 (S43).

The display modes of the first liquid crystal display 4 and the second liquid crystal display 5 during a typing game will now be described in accordance with the aforementioned example.

Under the conditions of the aforementioned specific example, when “song data (C)” is selected in the song selection process (S35), a typing game is executed based on “song data (C)”. Here, “song data (C)” is the song data of a song sung by a male artist.

Accordingly, when a typing game using “song data (C)” is executed, as shown in FIGS. 14A and 14B, the PV of (the male artist singing) this song is displayed on the second liquid crystal display 5, and the game screen of the typing game and one phrase (MOU MAYOWANAI) of the lyrics of this song, to be currently input, are displayed on the first liquid crystal display 4.

After one phrase of the lyrics of this song is displayed on the first liquid crystal display 4, the number of characters n, which are included in this phrase of lyrics data displayed on the first liquid crystal display 4, is acquired (S44). For example, “MOU MAYOWANAI” is displayed as one phrase of the lyrics data (see FIG. 14B), the number of characters (12) acquired by indicating one phrase of these lyrics in alphabet becomes the number of character n included in one phrase. After the number of characters n included in one phrase has been acquired, m indicating the number of characters input so far out of the phrase is set to 0 (S45).

In S46, it is determined whether or not any of the keys 300 arranged on the keyboard 3 has been typed out of the character strings of the phrase of the lyrics data displayed on the first liquid crystal display 4. If any of the keys 300 arranged on the keyboard 3 has been typed (S46: YES), the process moves to S49.

Conversely, if none of the keys 300 have been typed (S46: NO), it is determined whether a predetermined time period has elapsed since the display of the character strings related to the lyrics of the phrase, or since the previous character input (S47). If the predetermined time period has not elapsed (S47: NO), the process returns to S46 again to receive an input from a key 300. If the predetermined time period has elapsed without any input from a key 300 (S47: YES), the time period for inputting the characters to be currently input which relate to the lyrics of one phrase is regarded as having been lost. Accordingly, these characters are regarded as having being mistyped, thus adding “1” to the typing errors, and this sum is stored in the RAM 21 (S48). This typing error value is used to calculate a game score in a score calculation process (S51) to be described later. After “1” has been added to the typing errors and the sum is stored in the RAM 21, the process moves to S50.

In S49 to which the process moves when a key 300 is typed within the predetermined time period (S46: YES), an accuracy determination process regarding the key 300 typed is performed. In this accuracy determination process (S49), the accuracy of the key typed and precision in the timing of typing the key are determined based on the accuracy determination section 17, the timing determination section 18, and the determination reference data included in the song data.

In other words, in this accuracy determination process, with reference to the determination reference data, the accuracy determination section 17 determines whether keys 300 corresponding to the lyrics of the song have been typed or not. And, based on the determination reference data, the timing determination section 18 determines whether the typing timing of the key 300 typed is in accordance with the progress of the song.

For example, to describe a case using the aforementioned phrase “MOU MAYOWANAI”, when the key 300 of “U” is typed at the same time the artist of the song produces the sound “U” of “MOU MAYOWANAI”, the most favorable value is granted in the accuracy determination process.

After the accuracy determination process (S49) ends, in S50, a key emission process is performed. The key emission process is a process in which the aforementioned LEDs 302 disposed inside each key 300 of the keyboard 3 are caused to emit light. On this occasion, when a key 300 typed is correct, its LEDs 302 are caused to emit blue light, and when a key 300 typed is wrong, the LEDs 302 of the key 300 typed are caused to emit red light, while a correct key 300 is caused to emit blue light.

If a key 300 has not been typed within the predetermined time period (S47: YES), it is determined that the time period for typing a character, which should have been input, has been lost, and that the character has thus been mistyped. Therefore, a key 300 corresponding to the character which should have been input is caused to emit yellow light, thus notifying the player of the correct key 300.

The key emission process (S50) will now be described with reference to FIG. 15. For the sake of illustration, in FIG. 15, a key 300 emitting light is shown patterned so that it can be distinguished from keys 300 emitting no light. Accordingly, in FIG. 15, the key 300 of “M” is luminous, and the LEDs 302 disposed in the other keys 300 emit no light.

Referring to this FIG. 15, the emission modes of the keyboard 3 during a typing game will be described in accordance with the aforementioned specific example. One phrase “MOU MAYOWANAI” from the lyrics of the song is displayed on the first display 4, and “MOU” has already been input, in which case, when the player types the key 300 “M” which is the character to be input next, the key 300 “M” is made luminous in blue.

Besides, one phrase “MOU MAYOWANAI” from the lyrics of the song is displayed and “MOU” has already been input, in which case, when the predetermined time period has elapsed without the player's typing any key 300, a character “M” to be input next is made luminous in yellow.

To type a key 300, in many cases, a player who is poor at touch typing observes the keyboard 3 and thereby confirms the key 300 to be typed. Accordingly, even when the player who is poor at touch typing has failed to look at the first liquid crystal display 4, the keyboard 3 can lead such a player to recognize the correct input in a typing game. And, the acquisition of such information can lead such a player to improve typing skills through playing this typing game.

This embodiment is configured such that light is emitted in three colors, “red”, “yellow”, and “blue”, case by case based on the accuracy of a key 300 typed. However, the configuration is not limited thereto. The emission color may be varied based not only on the accuracy of the key 300 typed, but also on precision in the timing of typing the key 300. For example, the configuration may be such as follows. That is, when a key 300 typed is correct and the timing of typing the key 300 is also precise, the key 300 typed is made luminous in “blue”. When a key 300 typed is a correct one but the timing of typing the key is slightly off, the key 300 typed is made luminous in “green”. When a correct key 300 is typed but the timing of typing the key 300 is greatly off, the key 300 typed is made luminous in “orange”.

After the key emission process (S50) ends, the process moves to S51 to perform the score calculation process. In the score calculation process (S51), a game score is calculated based on the result of the process of S46 to S49, i.e., the result of typing a key 300 typed. In this embodiment, if the predetermined time period has elapsed without key typing having been performed (S48), or if a wrong key 300 has been typed, 0 is granted. If the CPU 10 determines that a correct key 300 has been typed, 200 is granted when the timing of typing is precise, 100 is granted when the timing of typing is slightly off, and 50 is granted when the timing of typing is greatly off.

After the score calculation process (S51) ends, 1 is added to m which indicates the number of characters currently input (S52). In S53, it is determined whether or not m indicating the number of characters currently input is equal to the value of the number of characters n forming one phrase of lyrics. If the numerical numbers of m and n are equal to one another, i.e., if the input of the lyrics of the phrase being currently input has ended (S53: YES), the process moves to S54. Conversely, if the input of characters included in the phrase has not ended (S53: NO), the process returns to S46 to receive input for the next character.

In S54, it is determined whether the song being reproduced in a typing game has ended or not. The end of the song is determined based on the process of inputting all the phrases of the lyrics data which are displayed on the first liquid crystal display 4, and based on whether the reproduction of image data, sound data, and performance data of the song data has ended or not. If the song has ended (S54: YES), the typing game execution process (S36) is brought to an end.

Conversely, if the song has not ended (S54: NO), the process returns to S43 so as to move to the input of the next phrase, and the typing game execution process (S36) continues.

A demonstration effect processing program to be executed in the demonstration effect process (S4) of the main control program will now be described in detail with reference to the drawings. FIG. 16 is a flowchart of the demonstration effect processing program.

In the typing game apparatus 1 of this embodiment, if no operation has been performed for a predetermined time period since the power activation thereof or the end of the execution of a typing game (S3: YES), the demonstration effect process (S4) is performed.

This demonstration effect process (S4) is a process for performing a music advertisement (e.g., the demonstration play of a typing game) and a commercial advertisement in the typing game apparatus 1.

When the process moves to the demonstration effect process (S4), first, in S61, data to be used in the current demonstration effect process (S4) is determined. To describe a case using the aforementioned specific example, data to be used in a demonstration effect is determined at random from among four pieces of song data: song data (B), song data (C), song data (D), and song data (E) stored in the song data storage area 20a, and three pieces of advertisement data: advertisement data (3), advertisement data (4), and advertisement data (5) stored in the advertisement data storage area 20b.

This embodiment is configured such that data to be used in a demonstration effect is determined at random from the data stored in the song data storage area 20a and the advertisement data storage area 20b. However, the configuration is not limited thereto, and may be such that data to be used in a demonstration effect is selected in a preset order. For example, if the configuration is such that the latest advertisement data, the latest song data, and the to-be-distributed song data are preferentially used in the demonstration effect, a demonstration play based on the latest song data will be frequently performed, thereby performing a music advertisement corresponding to the latest song data. In this case, it is possible to encourage a willingness to buy a music medium such as the CD and DVD of an artist related to the latest song data. Furthermore, in this case as well, it is possible to arouse an interest in the typing game apparatus 1.

When a demonstration play based on the to-be-distributed song data is frequently performed, similarly, it is possible to encourage a willingness to buy a music medium such as the CD and DVD of an artist related to the to-be-distributed song (i.e., the latest song or a song scheduled to be available shortly), which can thus arouse an interest in the typing game apparatus 1.

When a commercial advertisement is performed based on the latest advertisement data, the advertisement of a commercial product, which the client related to the commercial advertisement wishes to sell the most, will be frequently performed, which therefore makes it possible to effectively perform a commercial advertisement according to the wishes of the client related to the commercial advertisement.

For example, the advertisement of the CD of a new song by an artist is performed, thereby encouraging a willingness to buy the CD of the artist. In this case, spectators' interest in the artist is aroused, which therefore provides a strong motivation to execute a typing game using a song by the artist.

In S62, it is determined whether the data determined in S61 is advertisement data or not, i.e., whether to perform a commercial advertisement or a music advertisement (e.g., the demonstration play of a typing game).

To perform the commercial advertisement as a demonstration effect (S62: YES), the image data included in the advertisement data selected in S61 is read and displayed on the second liquid crystal display 5 (S63). Then, the game screen of the typing game such as a title screen is displayed on the first liquid crystal display 4 (S64).

After the image of the commercial advertisement data has been displayed on the second liquid crystal display 5 (S63) and the game screen has been displayed on the first liquid crystal display 4, the process moves to S66.

Thus, the commercial advertisement is performed on the second liquid crystal display 5, while the game screen is displayed on the first liquid crystal display 4, thereby making it possible, even when the commercial advertisement is being performed, to notify the player of what game can be played on the typing game apparatus 1.

On the other hand, when song data is selected in S61 to perform a music advertisement (the demonstration play of a typing game) (S62: NO), similar to the aforementioned typing game execution process (S36), images based on the image data of the song data are displayed. In other words, the game screen is displayed on the first liquid crystal display 4, while the image of the PV of the song is displayed on the second liquid crystal display 5 (S65) (FIGS. 14A and 14B). After the images have been displayed on the first liquid crystal display 4 and the second liquid crystal display 5, the process moves to S66.

In S66, sound data and performance data, which are included in the data to be used in a demonstration effect, selected in S61, are reproduced. In other words, when song data is selected to perform the demonstration play of a typing game, the voice of a singing artist related to the song and the sound of the accompaniment of the song by a musical instrument or the like are produced from the speakers 7.

On the other hand, to perform a commercial advertisement as a demonstration effect, sound data and performance data, which are included in the advertisement data, are reproduced. In other words, the voice of narration or the like of the commercial advertisement and the sound of the accompaniment of a musical instrument or the like, which is used as the background music of the commercial advertisement, are produced via the speakers 7.

In S67, the emission effects of the external illumination LEDs 6 and the LEDs 302 disposed in each key 300 are initiated based on the LED emission pattern data and the keyboard emission pattern data, which are included in the data to be used in the demonstration effect (S67).

Accordingly, to perform a music advertisement (e.g., the demonstration play of a typing game) based on song data, similar to when the typing game is performed, the emission effect of the external illumination LEDs 6 is performed based on the song data. An emission effect based on the keyboard emission pattern data included in the song data is performed on the keyboard 3.

For example, in the song, an emission effect is performed in the emission pattern in which correct keys 300 are made luminous when appropriate with the typing of the keys and the input timing which become a model capable of acquiring the highest score. In this case, this pattern may be included in the keyboard emission pattern data, or an emission effect may be performed by introducing this pattern based on the determination reference data of the song.

Even when a commercial advertisement is performed based on advertisement data, emission effects are performed based on the LED emission pattern data and the keyboard emission pattern data, which are included in the advertisement data. On this occasion, an emission effect is performed on the external illumination LEDs 6, via the light emission control section 24, in a pattern based on the LED emission data included in the advertisement data. An emission effect is also performed on the LEDs 302 disposed in each key 300, via the light emission control section 24, in an emission pattern (see FIGS. 19 and 21) based on the advertisement data.

This makes it possible to arouse an interest in the typing game apparatus 1 on which the commercial advertisement is being performed. Furthermore, the LED emission pattern data and the keyboard emission pattern data vary according to each piece of advertisement data. Therefore, an effect is performed in an emission mode (e.g., emission color and turning on and off) suited to the commercial advertisement, which can more deeply impress the commercial advertisement on the spectator. In other words, the advertising effect of the commercial advertisement can be increased.

At this point, in the typing game apparatus 1, based on data to be used in a demonstration effect, images are displayed on the first liquid crystal display 4 and the second liquid crystal display 5, and the sounds of sound data and performance data related to the data are produced from the speakers 7. Also, a variety of illumination effects are performed by the LED 302 inside each key 300 disposed on the keyboard 3 and the external illumination LEDs 6.

Each type of data: the image data, the sound data, the performance data, the LED emission pattern data, and the keyboard emission pattern data, which are included in the data, are reproduced when appropriate, thereby performing a music advertisement (e.g., the demonstration play of a typing game) or a commercial advertisement on the typing game apparatus 1.

When the reproduction of the data used in a demonstration effect ends (S68), the demonstration effect process (S4) is brought to an end.

The case in which a commercial advertisement is performed by reproducing advertisement data in the demonstration effect process will now be described using specific examples thereof.

The case, in which, in the aforementioned example, a commercial advertisement is performed using advertisement data (3) stored in the advertisement data storage area 20b, will first be described as a specific example. FIG. 18 is an illustration showing a display example of the second liquid crystal display 5 when a commercial advertisement is performed using advertisement data (3), and FIG. 19 is an illustration showing an emission mode of the keyboard 3 in the case of FIG. 18.

Here, advertisement data (3) is a commercial advertisement for a game software maker and for a role playing game now on sale.

Accordingly, when advertisement data (3) is selected in S61, then in S63, an advertisement screen, such as the game screen of the role playing game, is displayed on the second liquid crystal display 5. For example, as shown in FIG. 19, the second liquid crystal display 5 displays “NEW SENSATION RPG” which is the catchphrase of the role playing game, “□□□□□” which is the title of the role playing game, and “NOW ON SALE”.

On this occasion, the sound of narration “NEW SENSATION RPG, □□□□□, NOW ON SALE”, together with the sound of background music, is produced from the speakers 7.

At the same time, emission effects are performed by the external illumination LEDs 6 and the LEDs 302 as the display of the second liquid crystal display 5 and the sound production from the speakers 7 progress. The emission effect is performed on the external illumination LEDs 6 based on the LED emission pattern data of advertisement data (3), and the emission effect is performed on the keyboard 3 based on the keyboard emission pattern data of advertisement data (3).

To describe the emission pattern of the keyboard 3 in advertisement data (3), as shown in FIG. 19, out of five key rows arranged from front to back, the LEDs 302 of keys 300, which belong to the second and fourth key rows from the front, are luminous in red. Based on the elapse of a predetermined time period, keys 300 included in the second and fourth key rows from the front, which are currently activated, are turned off, and keys 300, which belong to the first, third, and fifth key rows from the front, are turned on in red. Furthermore, when a time period has elapsed, the second and fourth key rows are turned on again, and the first, third, and fifth key rows are turned off (see FIG. 19). This emission pattern is repeated until advertisement data (3) ends.

The emission effects are thus performed not only by the external illumination LEDs 6 but also by the keyboard 3, thereby making it possible to draw attention to a commercial advertisement related to advertisement data (3), which can increase its advertising effect. And, the roll playing game can be deeply impressed on the spectator.

The case, in which, in the aforementioned example, a commercial advertisement is performed using advertisement data (5) stored in the advertisement data storage area 20b, will now be described as a specific example. FIG. 20 is an illustration showing a display example of the second liquid crystal display 5 when a commercial advertisement is performed using advertisement data (5), and FIG. 21 is an illustration showing an emission mode of the keyboard 3 in the case of FIG. 20.

Here, advertisement data (5) is a commercial advertisement for a record company and for the CD of a new song by an artist scheduled to be available shortly.

Accordingly, when advertisement data (5) is selected in S61, then in S63, the advertising screen of the artist singing the new song or the like is displayed on the second liquid crystal display 5. For example, as shown in FIG. 20, the second liquid crystal display 5 displays the image of the artist singing the new song, and displays “OOOO” which is the name of the artist, “xxxx” which is the title of the new song CD, “ΔΔΔ Record Company” which is the name of the record company distributing the CD, and “Coming Soon”.

On this occasion, the voice of the narration “OOOO, NEW SINGLE, xxxx, Coming Soon, ΔΔΔ Record Company”, together with the sound of the new song, is produced from the speakers 7.

At the same time, emission effects are performed by the external illumination LEDs 6 and the LEDs 302 as the display of the second liquid crystal display 5 and the sound production from the speakers 7 progress. The emission effect is performed on the external illumination LEDs 6 based on the LED emission pattern data of advertisement data (5), and the emission effect is performed on the keyboard 3 based on the keyboard emission pattern data of advertisement data (5).

The emission pattern of the keyboard 3 for advertisement data (5) will now be described. As shown in FIG. 21, the emission pattern of the keyboard 3 in advertisement data (5) is an emission pattern having a different mode from in the aforementioned case of FIG. 19.

In other words, in the keyboard emission pattern of advertisement data (5), out of five key rows arranged from front to back, the emission effect is performed using the second to fifth key rows from the front. Out of the second to fifth key rows from the front, the first, fifth to seventh, and eleventh to thirteenth keys 300 from the left in each key row are luminous in green.

Based on the elapse of a predetermined time period, the LEDs 302 of keys 300, which are currently on, are turned off, and the LEDs 302 of keys 300 (the second to fourth and eighth to tenth keys from the left, ¥ key, and Enter key) included in the second to fifth key rows from the front, which are off currently, are turned on in green. When a second time period has elapsed, the key group of the second to fifth key rows, which has been on, is turned off again, and the key group, which has been off, is turned on. In other words, the emission mode shown in FIG. 21 is restored. This emission pattern is repeated until advertisement data (5) ends.

The emission effects are thus performed not only by the external illumination LEDs 6 but also by the keyboard 3, thereby making it possible to draw attention to a commercial advertisement related to advertisement data (5), which can increase the advertising effect. And, the new song by the artist can be more deeply impressed on the spectator.

Additionally, as described above, similar to advertisement data (3) and advertisement data (5), an emission effect can be performed in a unique emission pattern with respect to each piece of advertisement data, which therefore makes it possible to perform an emission effect in an emission pattern suited to the advertisement.

For example, in the case of advertising a song, the emission pattern may be set as follows. That is, light is emitted in accordance with the mood of the song, for example, in cold color if the song has a slow rhythm like that of a ballad, and on and off periods are set long, or light is emitted in warm color if the song has an aggressive rhythm like that of rock music, and light is turned on and off in quick tempo.

In other words, the emission pattern is set in response to the characteristic of a commercial product which is an advertising target, thereby making it possible to perform a commercial advertisement having a stronger advertising effect than when the commercial product is simply advertised using only an image.

A demonstration effect end condition monitoring program, which is executed, while performing an interrupt process when appropriate, during the execution of the demonstration effect process (S4), will now be described with reference to the drawings. FIG. 17 is the demonstration effect end condition monitoring program.

The demonstration effect end condition monitoring program is the program which is executed as the process moves to the aforementioned demonstration effect process (S4), and the program which forcibly brings the demonstration effect process to an end and moves the process to the typing game process (S3).

When the execution of a demonstration effect processing program is initiated, the execution of the demonstration effect end condition monitoring program is also initiated. And, in S71, it is determined whether any of the keys 300 arranged on the keyboard 3 have been typed or not.

If any key 300 has been typed (S71: YES), based on the demonstration effect processing program, the demonstration effect process (S4) is brought to an end (S72) even while a demonstration effect is being performed, and moves to the typing game process (S5) (S73).

Conversely, if none of the keys 300 arranged on the typing game apparatus I has been typed (S71: NO), the demonstration effect end condition monitoring program is directly brought to an end. In this case, if the demonstration effect process (S4) is being executed, the demonstration effect end condition monitoring program is executed again, while performing the interrupt process again, after the elapse of a predetermined time period.

As described so far, when no typing game is being executed, the typing game apparatus 1 of this embodiment can perform, as a demonstration effect, a music advertisement (e.g., the demonstration play of a typing game) based on song data and a commercial advertisement based on advertisement data. Even during no execution of a typing game on the typing game apparatus 1, this typing game apparatus 1 can thereby be effectively used.

In the typing game apparatus 1, the external illumination LEDs 6 and the keyboard 3 perform emission effects during the execution of a typing game and during the execution of a demonstration play and a commercial advertisement.

Accordingly, during the execution of a typing game, the mood of the song can be enhanced to provide a fully satisfactory effect, so that the player can soak in the ambiance of the song and can fully enjoy the typing game and the song.

Conversely, when no typing game is being executed, when a demonstration play is being performed, the external illumination LEDs 6 and the keyboard 3 perform emission effects, thereby making it possible to draw attention to the typing game machine 1 and increase a spectator's willingness to execute the typing game.

When a commercial advertisement is being performed, it is possible to draw a spectator's attention to the commercial advertisement and thus increase the appeal of the commercial advertisement.

In addition, the typing game apparatus 1 of this embodiment is linked to the server 80 via the network N, thus configuring the gaming system 100.

The typing game apparatus 1 receives a data list from the server 80, and can thereby delete expired song data and advertisement data from the HDD 20 and receive the distribution of the latest song data and the latest advertisement data.

Accordingly, a song to which a typing game can be played on the typing game apparatus 1 is updated when appropriate, which can always provide the typing game itself with fresh entertainment.

Besides, since old advertisement data is deleted and the latest advertisement data is distributed, a commercial advertisement to be performed when no typing game is being executed is prevented from becoming the advertisement of a commercial product which is no longer produced or distributed or an outdated commercial product. Thus, a timely commercial advertisement can always be performed, and the appeal of the commercial advertisement can be fully achieved.

The invention is not limited to the aforementioned embodiment, and can be modified in various ways without departing from the spirit of the invention. For example, this embodiment is configured such that the latest song data added to the song database 85a of the server 80 or the latest advertisement data newly added to the advertisement database 85b is automatically distributed to the typing game apparatus 1. However, the configuration is not limited to this mode.

In other words, the configuration may be such that the latest song data and the latest advertisement data are distributed in response to the demand of a shop installed with the typing game apparatus 1.

Additionally, this embodiment is configured such that, during the demonstration effect process, the PV of a song or the image of a commercial advertisement is displayed on the second liquid crystal display 5, while the game screen of a typing game is displayed on the first liquid crystal display 4. However, the configuration is not limited to this mode, and the display content of the first liquid crystal display 4 need not be the game screen.

For example, the configuration may be such as follows. That is, when the PV is being displayed, based on song data, on the second liquid crystal display 5, the same PV is also displayed on the first liquid crystal display 4, or information, such as the concert schedule of an artist related to the song, is displayed on the first liquid crystal display 4.

In the typing game apparatus 1 of this embodiment, a plurality of typing game apparatuses 1 and the server 80 are linked to one another via the network N, thereby configuring the gaming system 100. However, the configuration is not limited to this mode. For example, the configuration may be such as follows. That is, in a shop installed with a plurality of typing game apparatuses 1, a management server, which manages the typing game apparatuses 1 installed in the shop, is provided between the typing game apparatuses 1 and the server 80, and the management server is linked to the server 80 via the network N.

Additionally, this embodiment has a single server 80, but may be configured to have a central server system including a plurality of servers.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A typing game apparatus comprising:
a image display capable of displaying a character string to be input and an image during a typing game;
an input device for inputting the character string;
a sound production section for producing a sound based on music data;
an illumination section for performing a turning on and off effect;
a communication section which receives effect data, which includes image data, music data, and emission control data defining the emission mode of the illumination section, from a server having a database which stores the effect data; and
a CPU which displays a predetermined image on the image display, based on the effect data, when an input operation using the input device has not been performed for a predetermined time period, and which controls the emission mode of the illumination section based on the emission control data.

2. A typing game apparatus according to claim 1, wherein the image display includes:
a first image display for displaying the character string; and
a second image display for displaying a predetermined image based on the image data, and wherein the effect data includes:
song data which includes image data, music data, emission control data, and lyrics data, and which is used in conjunction with the typing game; and
advertisement data for use in a commercial advertisement, which includes image data, music data, and emission control data.

3. A typing game apparatus according to claim 2, wherein, upon reception of the advertisement data from the server through the communication section, the CPU displays an image of an advertisement on the second image display based on the image data, produces a sound through the sound production section based on the music data, and controls the emission mode of the illumination section based on the emission control data.

4. A typing game apparatus according to claim 2, wherein, upon reception of the song data from the server through the communication section, the CPU displays an image related to the song data to be used in a typing game, on the first image display, based on the image data of the song data, displays an image of a music advertisement corresponding to the song data on the second image display, produces a sound through the sound production section based on the music data of the song data, and controls the emission mode of the illumination section based on the emission control data of the song data.

5. A typing game apparatus according to claim 1, wherein
the input device is a keyboard having a translucent keycap and an emission section which emits light from below the keycap, wherein
the keyboard also functions as part of the illumination section.

6. A gaming system comprising:
a typing game apparatus according to claim 2; and
a server including a song database having the song data stored therein, an advertisement database having the advertisement data stored therein, and a transmission section which transmits both or any one of the song data and the advertisement data to the typing game apparatus.

7. A gaming system comprising:
a typing game apparatus according to claim 3; and
a server including a song database having the song data stored therein, an advertisement database having the advertisement data stored therein, and a transmission section which transmits both or any one of the song data and the advertisement data to the typing game apparatus.

8. A gaming system comprising:
a typing game apparatus according to claim 4; and
a server including a song database having the song data stored therein, an advertisement database having the advertisement data stored therein, and a transmission section which transmits both or any one of the song data and the advertisement data to the typing game apparatus.

9. A gaming system comprising:
a typing game apparatus according to claim 5; and
a server including a song database having the song data stored therein, an advertisement database having the advertisement data stored therein, and a transmission section which transmits both or any one of the song data and the advertisement data to the typing game apparatus.
